(19) United States
(12) Patent Application Publication
(10) Pub. No.: US 2008/0274792 A1
(43) Pub. Date: Nov. 6, 2008

(54) METHODS AND APPARATUS FOR FACILITATING GAMING SESSIONS VIA A SESSION TICKET

(76) Inventors: Jay S. WALKER, Ridgefield, CT (US); James A. Jorasch, Westport, CT (US); Robert C. Tedesco, Fairfield, CT (US); Patrick W. Nee, New York, NY (US); Russell P. Sammon, San Francisco, CA (US); Daniel E. Tedesco, Huntington, CT (US); Stephen C. Tulley, Monroe, CT (US); Matthew P. Ellenthal, Wilton, CT (US)

Correspondence Address: WALKER DIGITAL MANAGEMENT, LLC, 2 HIGH RIDGE PARK, STAMFORD, CT, 06905, US

(21) Appl. No.: 11/828,114

(22) Filed: Jul. 25, 2007

Related U.S. Application Data
(60) Provisional application No. 60/820,298, filed on Jul. 25, 2006.
(60) Provisional application No. 60/865,273, filed on Nov. 10, 2006.

(51) Int. Cl. A63F 9/24; G06F 17/00

(52) U.S. Cl. 463/25; 463/43

(57) ABSTRACT

In accordance with one or more embodiments, a session comprising a plurality of game plays of a wagering game may be initiated via a session ticket. A session ticket may comprise, for example, a paper substrate, a plastic card or information stored electronically (e.g., in a wireless handheld device). In one embodiment, a casino property may manage a promotion by providing session tickets to players free of charge (e.g., to an audience of a show, to encourage the audience to gamble on the casino floor at the end of the show). In one embodiment, a session ticket may be sold as part of a Value Package that includes one or more gambling items (e.g., a session ticket for a session) and one or more non-gambling items (e.g., a voucher to a casino restaurant or spa and a reservation for a hotel room).

The present application claims the benefit of the following two provisional applications:
(i) U.S. Provisional Application Ser. No. 60/820,298 filed on Jul. 25, 2006 and entitled VOUCHERS FOR FACILITATING FLAT RATE PLAY SESSIONS; and
(ii) U.S. Provisional Application Ser. No. 60/865,273 filed on Nov. 10, 2006 and entitled VOUCHERS AND OTHER MEDIA FOR FACILITATING FLAT RATE PLAY SESSIONS.

Each of these provisional applications is incorporated by reference herein for all purposes.

The present application is also related to the following patents and applications:
(i) U.S. patent application Ser. No. 09/518,760 filed on Mar. 3, 2000 and entitled GAMING DEVICE FOR A FLAT RATE PLAY SESSION AND A METHOD OF OPERATING SAME and issued as U.S. Pat. No. 6,319,127 on Nov. 20, 2001.
(ii) U.S. patent application Ser. No. 08/880,838 filed on Jun. 23, 1997 and entitled GAMING DEVICE FOR A FLAT RATE PLAY SESSION AND A METHOD OF OPERATING SAME and issued as U.S. Pat. No. 6,077,163 on Jun. 20, 2000.
(iii) U.S. patent application Ser. No. 11/425,044 filed on Jun. 19, 2006 and entitled GAMING DEVICE FOR A FLAT RATE PLAY SESSION AND A METHOD OF OPERATING SAME.
(iv) U.S. patent application Ser. No. 11/425,041 filed on Jun. 19, 2006 and entitled GAMING DEVICE FOR A FLAT RATE PLAY SESSION AND A METHOD OF OPERATING SAME.
(v) U.S. patent application Ser. No. 11/425,037 filed on Jun. 19, 2006 and entitled GAMING DEVICE FOR A FLAT RATE PLAY SESSION AND A METHOD OF OPERATING SAME.
(vi) U.S. patent application Ser. No. 11/293,016 filed on Dec. 2, 2005 and entitled GAMING DEVICE FOR A FLAT RATE PLAY SESSION AND A METHOD OF OPERATING SAME.
(vii) U.S. patent application Ser. No. 10/986,529 filed on Nov. 10, 2004 and entitled GAMING DEVICE FOR A FLAT RATE PLAY SESSION AND A METHOD OF OPERATING SAME.
(viii) U.S. patent application Ser. No. 10/985,131 filed on Nov. 10, 2004 and entitled GAMING DEVICE FOR A FLAT RATE PLAY SESSION AND A METHOD OF OPERATING SAME and issued as U.S. Pat. No. 7,156,739 on Jan. 2, 2007.
(ix) U.S. patent application Ser. No. 10/001,089 filed on Nov. 2, 2001 and entitled GAMING DEVICE FOR A FLAT RATE PLAY SESSION AND A METHOD OF OPERATING SAME and issued as U.S. Pat. No. 7,140,964 on Nov. 28, 2006; which claims priority to U.S. Provisional Patent Application No. 60/282,792 filed on Apr. 10, 2001.
(x) U.S. patent application Ser. No. 11/691,065 filed on Mar. 26, 2007 and entitled METHOD AND APPARATUS FOR EMPLOYING FLAT RATE PLAY.
(xi) U.S. patent application Ser. No. 11/691,015 filed on Mar. 26, 2007 and entitled METHOD AND APPARATUS FOR EMPLOYING FLAT RATE PLAY.
(xii) U.S. patent application Ser. No. 11/428,642 filed on Jul. 5, 2006 and entitled METHOD AND APPARATUS FOR EMPLOYING FLAT RATE PLAY.
(xiii) U.S. patent application Ser. No. 11/428,638 filed on Jul. 5, 2006 and entitled METHOD AND APPARATUS FOR EMPLOYING FLAT RATE PLAY.
(xiv) U.S. patent application Ser. No. 10/420,066 filed on Apr. 21, 2003 and entitled METHOD AND APPARATUS FOR EMPLOYING FLAT RATE PLAY; which claims the benefit of priority of U.S. Provisional Patent Application No. 60/374,385, filed on Apr. 19, 2002.
(xv) U.S. Divisional application Ser. No. 11/361,152 filed on Feb. 24, 2006 and entitled GAMING TOKEN HAVING A VARIABLE VALUE.
(xvi) U.S. Divisional application Ser. No. 11/331,550 filed on Jan. 13, 2006 and entitled GAMING TOKEN HAVING A VARIABLE VALUE.
(xvii) U.S. Divisional application Ser. No. 11/329,872 filed on Jan. 11, 2006 and entitled GAMING TOKEN HAVING A VARIABLE VALUE.
(xviii) U.S. Divisional application Ser. No. 11/321,793 filed on Dec. 29, 2005 and entitled GAMING TOKEN HAVING A VARIABLE VALUE.
(iixx) U.S. patent application Ser. No. 09/597,801 filed on Jun. 20, 2000 and entitled GAMING TOKEN HAVING A VARIABLE VALUE; which claims the benefit of priority of 60/202,573 filed on May 10, 2000 and entitled GAMING TOKEN HAVING A VARIABLE VALUE.
(ixx) U.S. Provisional Patent Application No. 60/600,211 filed on Aug. 10, 2004 and entitled SYSTEMS, METHODS AND APPARATUS FOR FACILITATING PLAY OF A GAMING DEVICE IN ACCORDANCE WITH A CONTRACT.
(xx) U.S. patent application Ser. No. 11/428,606 filed on Jul. 5, 2006 and entitled SYSTEMS, METHODS AND APPARATUS FOR FACILITATING A FLAT RATE PLAY SESSION ON A GAMING DEVICE AND EXAMPLE PLAYER INTERFACES TO A FACILITATE SUCH.
(xxi) U.S. patent application Ser. No. 11/428,605 filed on Jul. 5, 2006 and entitled SYSTEMS, METHODS AND APPARATUS FOR FACILITATING A FLAT RATE PLAY SESSION ON A GAMING DEVICE AND EXAMPLE PLAYER INTERFACES TO A FACILITATE SUCH.
(xxii) U.S. patent application Ser. No. 11/270,016 filed on Nov. 9, 2005 and entitled SYSTEMS, METHODS AND APPARATUS FOR FACILITATING A FLAT RATE PLAY SESSION ON A GAMING DEVICE AND EXAMPLE PLAYER INTERFACES TO A FACILITATE SUCH; which claims the benefit of Provisional Patent Application No. 60/679,138 filed on May 9, 2005 and entitled SYSTEMS, METHODS AND APPARATUS FOR FACILITATING A FLAT RATE PLAY SESSION ON A GAMING DEVICE AND EXAMPLE PLAYER INTERFACES TO A FACILITATE SUCH; U.S. Provisional Patent Application No. 60/637,338 filed on Dec. 17, 2004 and entitled GAMING DEVICE OFFERING A FLAT RATE PLAY SESSION AND METHODS THEREOF; U.S. Provisional Patent Application No. 60/627,670 filed on Nov. 12, 2004 and entitled GAMING DEVICE OFFERING A FLAT RATE PLAY SESSION AND METHODS THEREOF.
(xxiii) U.S. patent application Ser. No. 10/792,014 filed on Mar. 3, 2004 and entitled METHOD AND APPARATUS FOR BOUNDING PLAY OF A GAMING DEVICE; which claims the benefit of priority of U.S. Provisional Patent Application No. 60/451,969 filed on Mar. 4, 2003 and entitled METHOD AND APPARATUS FOR BOUNDING PLAY OF A GAMING DEVICE.
(xxiv) U.S. patent application Ser. No. 11/423,055 filed on Jun. 8, 2006 and entitled SYSTEM AND METHOD FOR COMMUNICATING GAME SESSION INFORMATION.
(xxv) U.S. patent application Ser. No. 11/423,043 filed on Jun. 8, 2006 and entitled SYSTEM AND METHOD FOR COMMUNICATING GAME SESSION INFORMATION.
(xxvi) U.S. patent application Ser. No. 11/423,037 filed on Jun. 8, 2006 and entitled SYSTEM AND METHOD FOR COMMUNICATING GAME SESSION INFORMATION.
(xxvii) U.S. patent application Ser. No. 10/636,520 filed on Aug. 7, 2003 and entitled SYSTEM AND METHOD FOR COMMUNICATING GAME SESSION INFORMATION; which claims the benefit of priority of U.S. Provisional Application No. 60/401,852 filed on Aug. 7, 2002 and entitled SYSTEM AND METHOD FOR COMMUNICATING GAME SESSION INFORMATION.
(xxviii) U.S. patent application Ser. No. 10/908,957 filed on Jun. 2, 2005 and entitled METHOD AND APPARATUS FOR FACILITATING PLAY OF A GAMING DEVICE; which claims the benefit of priority of U.S. Provisional Patent Application No. 60/581,557 filed on Jun. 21, 2004 and entitled METHOD AND APPARATUS FOR FACILITATING PLAY OF A GAMING DEVICE.
(xxix) U.S. patent application Ser. No. 11/303,385 filed on Dec. 16, 2005 and entitled FACILITATING PLAY OF A GAMING DEVICE IN ACCORDANCE WITH A CONTRACT.

Each of the above mentioned related patents and applications are incorporated by reference herein for all purposes.

### FIELD

The present application relates to sessions of gambling which a player may purchase for a flat rate price or otherwise obtain. Such a session includes a plurality of game plays of a wagering game and may be provided (e.g., sold) to a player for a discounted price (e.g., discounted from what the player would otherwise pay for the game plays if the player were to pay for each game play individually).

### BRIEF DESCRIPTION OF THE FIGURES

FIG. 1 illustrates a block diagram of an example system that may be used to implement one or more embodiments described herein.

FIG. 2 illustrates a block diagram of an example of a gaming device that may be used to implement one or more embodiments described herein.

FIG. 3 illustrates a block diagram of an example of a controller that may be used to implement one or more embodiments described herein.

FIG. 4 illustrates a table of an example of an available sessions database storing information about sessions available for provision to players, in accordance with one or more embodiments described herein.

FIG. 5 illustrates a table of an example of a session groupings database storing information about groups of sessions available for provision to players, in accordance with one or more embodiments described herein.

FIG. 6 illustrates a table of an example of a session tickets database storing information about tickets created for provision to players, in accordance with one or more embodiments described herein.

FIG. 7 illustrates a table of an example active sessions database storing information about sessions currently in progress, in accordance with one or more embodiments described herein.

FIGS. 8A and 8B illustrate, respectively, a front and back view of a session ticket comprising a paper substrate, in accordance with one or more embodiments described herein.

FIG. 9 illustrates an example of an embodiment of a plastic card comprising a session ticket and an embodiment of a token or chip comprising a session ticket, in accordance with one or more embodiments described herein.

FIG. 10 illustrates a flowchart of an example process that may be used to implement one or more embodiments described herein.

FIG. 11 illustrates a flowchart of another example process that may be used to implement one or more embodiments described herein.

FIG. 12 illustrates an interface for a software module that may b used to implement one or more embodiment described herein.

### DETAILED DESCRIPTION

Described in previously-filed and commonly-owned Patents and Patent Applications are various methodologies and systems for facilitating a session of a game at a gaming device or table game by allowing a player to purchase a plurality of game plays of a game or a block of game plays of a game (e.g., a block of spins of a reeled slot machine, a plurality of hands of poker, video poker, blackjack or video blackjack, a plurality of spins of a roulette wheel) for a price that is less than the sum of the individual prices of each of the game plays included in the plurality if a player were to purchase the rounds individually. The interested reader may refer to, for example, U.S. Pat. No. 7,140,964, issued on Nov. 28, 2006 to Walker et al. and entitled GAMING DEVICE FOR A FLAT RATE PLAY SESSION AND A METHOD OF OPERATING SAME and U.S. application Ser. No. 11/270,016, filed Nov. 9, 2005 in the name of Walker et al. and entitled SYSTEMS, METHODS AND APPARATUS FOR FACILITATING A FLAT RATE PLAY SESSION ON A GAMING DEVICE AND EXAMPLE PLAYER INTERFACES TO A FACILITATE SUCH for a more detailed explanation of some example manners in which a session may be priced.

Applicants have recognized that such sessions may be effectively sold, updated, facilitated, managed and promoted via tangible media such as a session ticket, as the term is described elsewhere herein.

Applicants have also recognized that the availability of such sessions for purchase by, or gift or prize to, a player provides unique opportunities for a casino to more efficiently manage its entire property (e.g., its restaurant, entertainment, hotel and shopping venues as well as its gambling venues). Applicants describe herein various uses for session tickets for maximizing such opportunities. Applicants further describe herein various methods and systems for determining and effecting the creation and distribution of such session tickets to maximize revenue opportunities for a casino property.

The present disclosure contemplates allowing players to operate a gaming device via inserting a session ticket into the gaming device or otherwise indicating a session ticket identifier and/or other information associated with the session ticket to a gaming device (e.g., entering a session code, inserting session card, etc.).

The present disclosure contemplates, in accordance with some embodiments, a gaming device operable to determine information from a session ticket, transmit at least part of the information to a server and, in response to the transmittal, receive further information about a session associated with the session from the server. In other embodiments, the present disclosure contemplates a gaming device determining session information associated with a session ticket locally (i.e., with no or limited communication with a server to determine such session information). The present disclosure further contemplates allowing, upon a session ticket being inserted into a gaming device or session ticket information being otherwise indicated to the gaming device, a configuration of the gaming device to facilitate a particular session as defined by such a session ticket.

The present disclosure also contemplates methods and systems for determining the creation and distribution of session tickets (e.g., how many session tickets to print or otherwise issue, who to issue the session tickets to, the value(s) of parameter(s) of the session defined by a session ticket, etc.). For example, a software module for the management of casino promotions via session tickets may be operated by casino personnel to facilitate such personnel in directing the printing of a stack of session tickets for disbursement to patrons leaving a show at a casino property. Such a module may allow casino personnel to customize the stack of tickets based on one or more of (i) utilization of gaming devices (e.g., at time of ticket printing or as anticipated at time of show letting out); (ii) current games being promoted; (iii) availability of games or gaming devices; (iv) current areas of a casino floor being promoted; (v) regulatory compliance concerns; and (vi) promotional budget concerns. Other events that may provide opportune times for a printing or other provision of promotional session tickets are described herein.

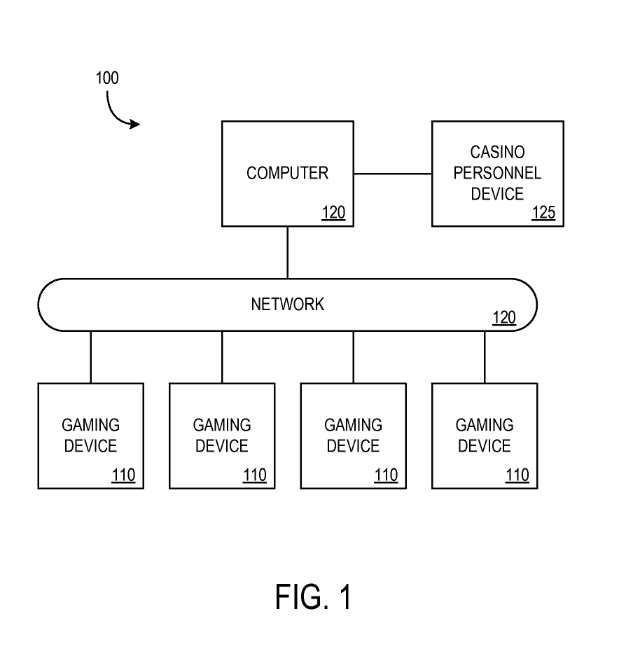

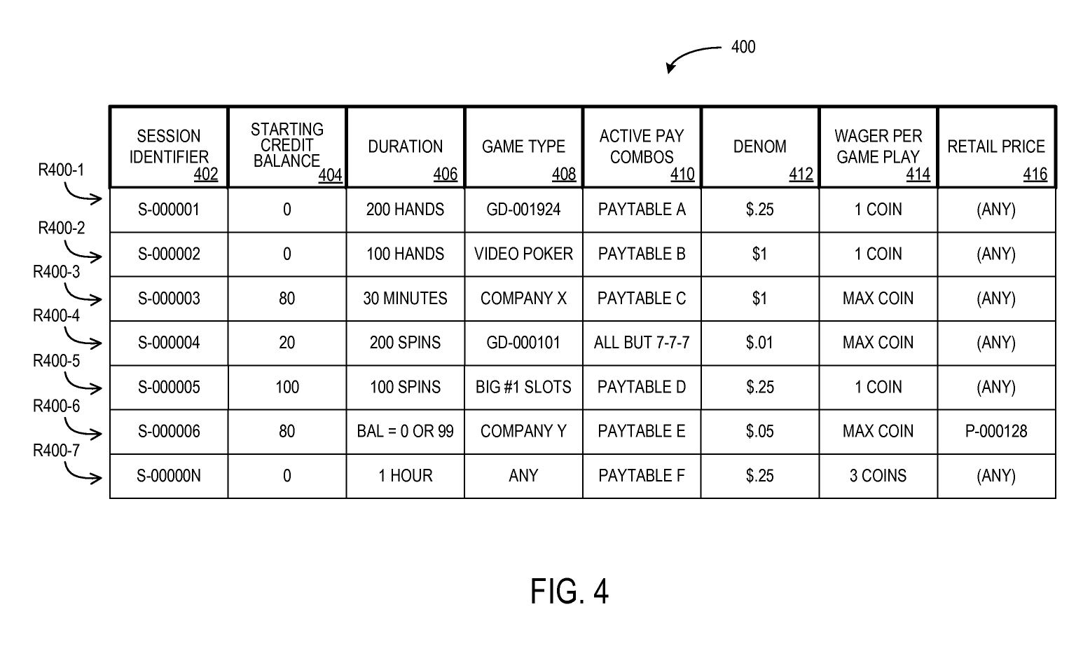

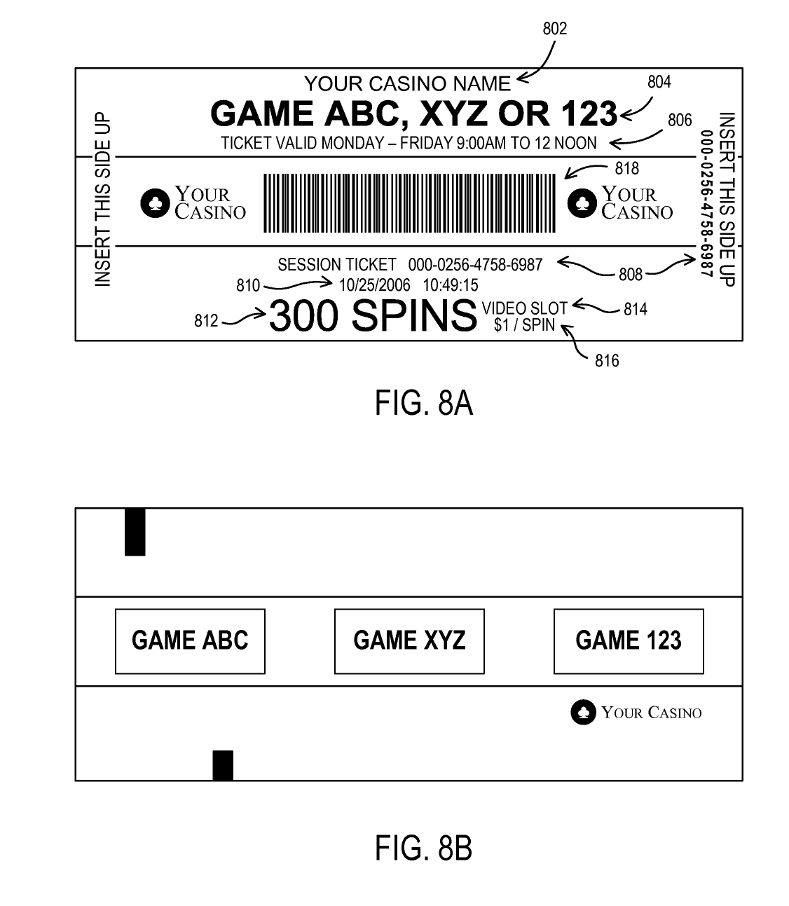

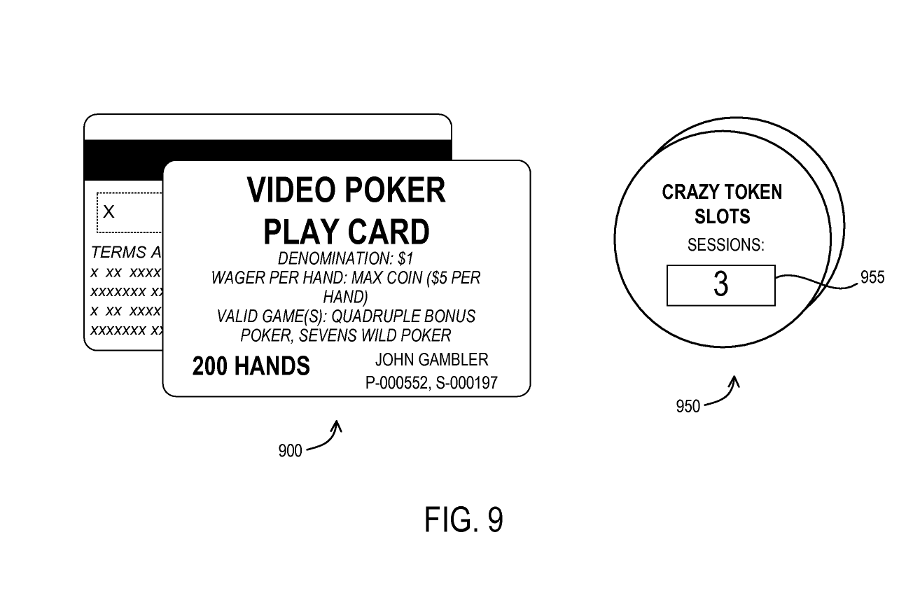

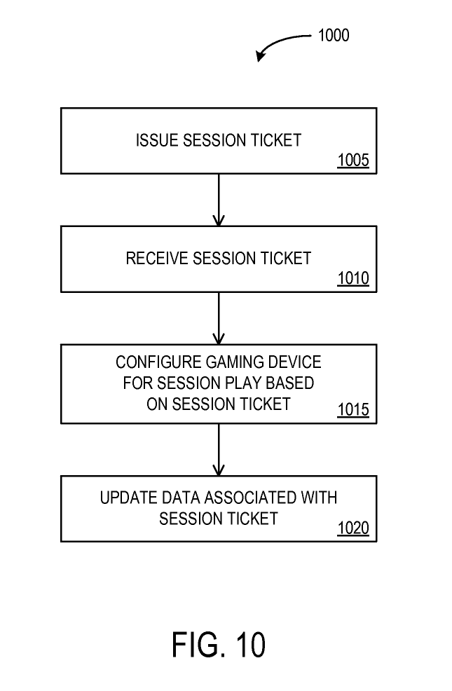

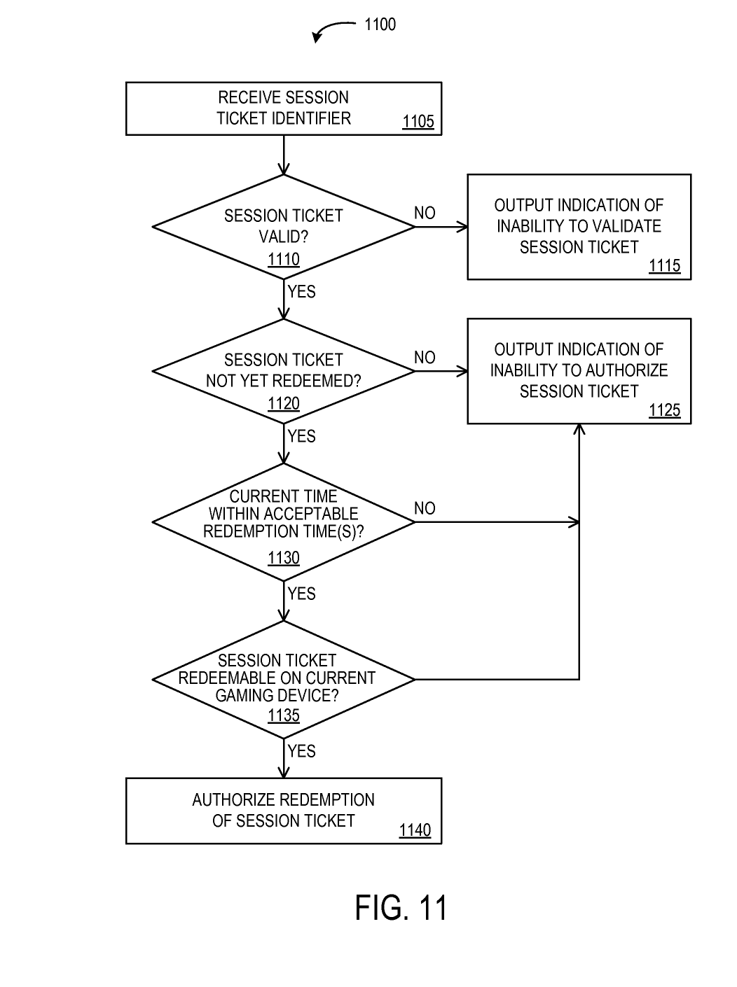

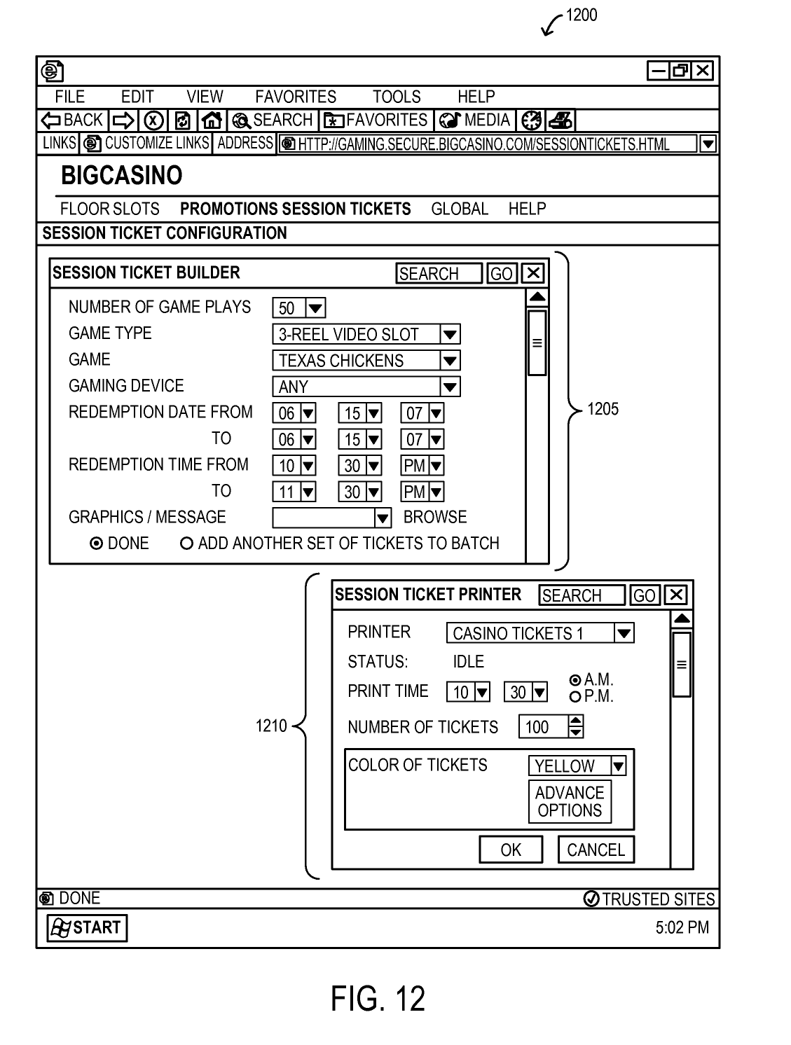

Some terms useful in describing embodiments of the present invention will now be described, to aid the reader in understanding the present disclosure. Following a description of the terms is a description of some hardware (with respect to FIGS. 1-3) which may be useful in implementing embodiments described herein. Following the description of the hardware is a description of some tables which may be used to implement one or more embodiments described herein (with respect to FIGS. 4-7). Following the description of the tables is a description of some example embodiments of session tickets (with respect to FIGS. 8 and 9), which is followed by a description of some processes which may be used to implement one or more embodiments (with respect to FIGS. 10 and 11). A description of an example interface for casino personnel for a software module which may be used to manage casino promotions via session tickets is described with reference to FIG. 12. This description is followed by a description of some additional embodiments (e.g., using session tickets in packages offered for sale by a casino) and some additional description of some embodiments. Finally, some Rules of Interpretation for interpreting terminology in the present disclosure is provided.

The term “session ticket” as it is used herein unless otherwise specified, refers to a paper substrate, other tangible medium or other indicator (e.g., virtual ticket stored in a player account in association with a player identifier) that evidences that its holder is entitled to a session of a game. The session ticket will in many cases include an indication of a session, including an indication of one or more value(s) of one or more parameter(s) of the session (e.g., the retail price of the session, the maximum bet per game play of the session, the denomination to be played, one or more players who may utilize the session ticket, the game(s) the session may be redeemed for, the gaming device(s) at which the session may be redeemed and/or the paytable to be used for the session). A session ticket may comprise, for example, a voucher, coupon, card, token, certificate, receipt, document, marker, note, pass, record, slip or any combination of attributes of any of the above. A session ticket may be purchased (e.g., for the price of the session indicated on the session ticket) or provided as a gift or comp to a player. A session ticket may or may not be transferable to another player. A session ticket may or may not be associated with another session ticket (e.g., a session ticket may include a meta-identifier that is included on a group of tickets printed, created, sold and/or otherwise provided together). In one example embodiment, a session ticket may comprise a bar-coded ticket readable by (and perhaps printed by) a ticketin/ticket-out (TITO) module of a gaming device (e.g., an EZ Pay™ TITO device such as manufactured by IGT™ Of Reno, Nev.).

The term “session” as used herein and unless otherwise specified, comprises a plurality of game plays of one or more games (played or playable at one or more gaming devices) which has an identifiable beginning and an identifiable end (although can include pauses or breaks) and for which a single price is paid (typically prior to initiation of the session) or which is provided to a player as a promotion or comp. A retail price or value of a session typically is lower than the sum of the prices of the individual game plays encompassed by the session. For example, if a player purchases a session defining fifty game plays at a $1.00 wager per game play, the player will typically pay less per game play than if the player were to purchase the fifty game plays individually and wager $1.00 per game play (i.e., in the latter scenario the player would pay $50.00 while in the former the player would typically pay less than $50.00).

In some embodiments, a player to whom a session is sold or otherwise provided or who is otherwise entitled to the session may be referred to as a beneficiary of the session. A player may be entitled to a session if, for example, a player may claim a right to execute a session (e.g., based on a session ticket sold or otherwise provided to the player).

A session is defined via a plurality of parameters and a value for each parameter. Examples of parameters include: (i) a duration of the session (e.g., 200 game plays, 30 minutes, until a particular payout or payout of a predetermined magnitude is won, until a predetermined number of symbols or outcomes is obtained or some other predetermined event occurs); (ii) a retail price of the session; (iii) a game(s) for which the session can be redeemed; (iv) a gaming device(s) or table game at which the session may be redeemed; (v) a denomination of currency in which wagers of the game during the session are defined; (vi) a wager per game play of the session (which can be fixed for the duration of the session or which can be varied during the session in some embodiments); (vii) an expiration date beyond which the session is no longer valid; (viii) a time and/or period of time (e.g., day of week or month, time of day, etc.) during which the session can be redeemed, (ix) a paytable to be used for determining payouts won during the session; (x) a probability table to be used for determining outcome won during the session; (xi) paylines and/or payout combinations to be active during the session. Other examples of parameters which may be used to define a session are described in the Related Applications cited above.

When a player redeems a session, the player agrees to abide by the parameters (and values thereof) of the session. Accordingly, a session may be thought of as a contract between the player and the casino or other provider of the session.

An outcome, as the term is used herein unless indicated otherwise, refers to a result of a game play, which may be indicated by a payout (i.e., a prize or benefit to be provided as a result of the game play) and/or one or more indicia representative of the result. For example, an outcome may comprise the set of indicia (or payout corresponding thereto) that may be displayed along a payline of a reeled slot machine. In another example, an outcome may comprise a roulette number that is a result of a roulette spin. In another example, an outcome may comprise a push in a game of blackjack. In some embodiments, more than one set of indicia may represent the same result or outcome.

In one embodiment, an outcome may be represented via indicia of a media file. A media file may comprise graphical and/or audio data. The graphical data may comprise a still or animated image of one or more indicia. In some embodiments, more than one media file may correspond to a particular outcome or result. For example, more than one media file may correspond to an outcome that results in zero credits being added to a credit meter balance.

A game, as the term is used herein unless indicated otherwise, comprises a wagering activity conducted in accordance with a particular set of rules via which a prize or benefit may be won in exchange for consideration.

A game play, as the term is used herein unless indicated otherwise, refers to a single instance or round of a game. A game play may result in a single outcome (e.g., set of indicia and corresponding payout, if any). (e.g., a player pulls the handle of a slot machine and the reels resolve to “Bar-Lemon-Plum”, the player plays a hand of blackjack at a table which results in a push). In some embodiments, a game play may comprise a bonus round. It should be noted that the term “round” does not imply a plurality of participants (e.g., as in a round of a card game) nor does it imply a relationship with a plurality of rounds (e.g., as in a game the outcome of which is determined based on events during a plurality of rounds of the game). It should further be noted that, as appropriate, the term “handle pull”, “spin” or “hand” is used interchangeably with the term “game play” or “round.” For example, in describing an example embodiment involving a reeled slot machine, the term “spin” or “handle pull” may be used while describing an example embodiment involving a video poker game or blackjack game, the term “hand” may be used.

A type of game, as the term is used herein unless indicated otherwise, refers to a category of games that share one or more characteristics.

A credit balance, in at least one embodiment, comprises a balance of credits available for wagering or otherwise indicated whether the player has, in aggregate, won or lost credits. A credit balance, in at least one embodiment, is a mechanism for tracking a player's progress through a single or multiple game plays of a wagering game by means of a number of units of wager. The unit of wager may be arbitrarily defined or may correspond to a value of currency (e.g., one unit of wager, or credit, is equal to a single 25¢ coin). Such a mechanism may be implemented via software and/or hardware. For example, a program may include instructions for tracking the player's progress by (i) deducting, for each game play of a game, an appropriate number of credits or units of wager from the credit balance and (ii) adding, for each game play of the game, an appropriate number of credits or units of wager to the credit balance for each winning outcome achieved by the player. An example of hardware that may be used to implement a credit balance may comprise a display (e.g., a touchscreen or LED display) that indicates a credit balance to a player and the adjustments thereto as a result of game play.

In some embodiments, more than one balance of credits available for wagering may be tracked. For example, a “machine balance” of credits may be tracked, comprising credits which may be used to purchase a session or otherwise gamble at a gaming device. Additionally, a “session balance” of credits may be tracked once a session is initiated, to track a player's progress during a session. In some embodiments, a purchase of a session may result in a number of credits being deduced from the machine balance (based on the price of the session). The initiation of the session may result in the session balance being set to zero or another number of credits.

A negative credit balance, in at least one embodiment, may comprise a balance of credits or other units of wager that is less than zero. For example, if in a particular session it is permissible to allow a negative credit balance, a player with a balance of seven credits may place a 10-credit wager and receive a non-winning outcome, thereby resulting in a balance of −3 credits. In other embodiments, a negative balance of credits may comprise a positive amount of a secondary type of credits. For example, a player may have a positive balance of credits of a primary type (e.g., 12 “standard” game credits), as well as a positive balance of credits of a secondary type (e.g., 17 “loaned”, promotional or non-cashable and non-taxable game credits). Negative credits, in at least one embodiment, may refer to (i) credits of a balance that is currently less than zero (e.g., if a credit balance is −5, a player can be thought to posses five negative credits), (ii) a positive amount of credits that negatively affect (negate, offset, reduce the value of) another type of credits (e.g., “loaned” credits reduce the value of “standard” credits), and/or (iii) non-cashable or otherwise illiquid credits (e.g., that have been loaned to a player, which the player may or may not be obligated to repay). Various aspects of negative credits and a negative credit balance as it relates to a session are described in detail in commonly-owned U.S. application Ser. No. 11/530,757, filed Sep. 11, 2006 and which is already incorporated by reference herein.

A payout, in at least one embodiment, may refer to a benefit provided to a player as the result of an outcome (e.g., at the end of a bonus round, a player is paid 120 credits). For example, in some embodiments, a payout comprises a number of credits added to a balance represented by an electronic credit meter (e.g., a winning outcome of “Lemon-Lemon-Lemon” pays five credits). In some embodiments wherein a current credit balance is negative, adding credits to such a balance may have the effect of reducing the negative number (e.g., if a player has a balance of −23 credits and the player wins 11 credits, the current balance becomes −12). Thus, in some embodiments, a payout may comprise the forgiveness of a loan. A payout need not necessarily be provided to a player at the time an outcome corresponding to the payout is determined and/or by the gaming device that determines the outcome.

Referring now to FIG. 1, an example embodiment 100 of a system in accordance with one or more embodiments is depicted in block diagram form. Embodiment 100 is referred to as system 100 herein. The present invention can be configured to work as a system 100 in a network environment including a controller 105 (e.g., a slot server of a casino) that is in communication, via a communications network 120, with one or more gaming devices 110 (e.g., slot machines, video poker machines, etc.) and with one or more casino personnel devices 125. The controller 105 may communicate with any and all of the gaming devices 110 and/or casino personnel devices 125 directly or indirectly, via a wired or wireless medium such as the Internet, LAN, WAN or Ethernet, Token Ring, or via any appropriate communications means or combination of communications means. Each of the gaming devices 110 may comprise computers, such as those based on the Intel® Pentium® processor, that are adapted to communicate with the controller 105. Any number, type and/or number of types of gaming devices 110 may be in communication with the controller 105.

Communication between the gaming devices 110, the casino personnel devices 125 and the controller 105 and/or among the gaming devices 110 may be direct or indirect, such as over the Internet through a Web site maintained by computer on a remote server or over an on-line data network including commercial on-line service providers, bulletin board systems and the like. In yet other embodiments, the gaming devices 110 may communicate with one another and/or the controller 105 over RF, cable TV, satellite links and the like.

Some, but not all, possible communication networks that may comprise the network 120 or be otherwise part of the system 100 include: a local area network (LAN), a wide area network (WAN), the Internet, a telephone line, a cable line, a radio channel, an optical communications line, and a satellite communications link. Possible communications protocols that may be part of the system include: Ethernet (or IEEE 802.3), SAP, ATP, Bluetooth™, and TCP/IP. Communication may be encrypted to ensure privacy and prevent fraud in any of a variety of ways well known in the art.

A variety of communications protocols may be part of the system 100 or another system operable to facilitate the embodiments described herein, including but not limited to: Ethernet (or IEEE 802.3), SAP, SAS™, SuperSAS™, ATP, Bluetooth™, and TCP/IP. Further, in some embodiments, various communications protocols endorsed by the Gaming Standards Association of Fremont, Calif., may be utilized, such as (i) the Gaming Device Standard (GDS), which may facilitate communication between a gaming device and various component devices and/or peripheral devices (e.g., printers, bill acceptors, etc.), (ii) the Best of Breed (BOB) standard, which may facilitate communication between a gaming device and various servers related to play of one or more gaming devices (e.g., servers that assist in providing accounting, player tracking, content management, ticket-in/ticket-out and progressive jackpot functionality), and/or (iii) the System-to-System (S2S) standard, which may facilitate communication between game-related servers and/or casino property management servers (e.g., a hotel server comprising one or more databases that store information about booking and reservations). Communication may be encrypted to ensure privacy and prevent fraud in any of a variety of ways well known in the art.

In some embodiments, a controller 105 may not be necessary and/or preferred. For example, one or more embodiments may be practiced on a stand-alone gaming device 110 and/or a gaming device 110 in communication only with one or more other gaming devices 110 (i.e., without a controller 105). In such embodiments, any functions described as performed by the controller 105 or data described as stored on the controller 105 may instead be performed by or stored on one or more gaming devices 110.

Further, as described herein, some embodiments of the invention may be practiced at a table game (e.g., a standard physical table, a smart table, a virtual electronic table with a simulated dealer, etc.). For example, a dealer at a standard physical table may collect a session ticket, a session ticket may be inserted into a TITO device associated with a table, or a player may enter a session code into an electronic interface associated with a table. In such table game embodiments, a controller may or may not be used (e.g., a smart table embodiment may use a controller 105 but a conventional non-electronic table embodiment may not).

The controller 105 may comprise, in at least some embodiments, an electronic device (e.g., a computer) that is operable to communicate with one or more gaming devices 110. In some embodiments, controller 105 may function as a computer server and may control or direct at least some processes of gaming devices. Alternately or additionally, the controller 105 may contain or otherwise be configured to read data from and/or write data to one or more databases of one or more of the gaming devices 110. Such data may comprise, for example, probability data, payout data, player data, and so on. In some embodiments, outcomes may be “centrally-determined” by controller 105 or another device that is distinct from the gaming devices 110. Such centrally-determined outcomes may then be promulgated to one or more gaming devices 110, such that they may be received by players.

In one embodiment, controller 105 may in turn be in communication with another electronic device (not shown) that is distinct from a gaming device 110, which electronic device may be operable to (i) direct the controller 105 to perform certain functions and/or (ii) read data from and/or write data to the controller 105. For example, the controller 105 may comprise a slot server or Data Collection Unit (DCU) that controls and/or communicates with a bank of gaming devices, which server or DCU is in turn in communication with a casino server that is in communication with a plurality of controllers. In another embodiment, the controller 105 may be operable to communicate with the one or more gaming devices 110 via another electronic device (e.g., a DCU), such as a server computer operable to communicate with a plurality of gaming devices. For example, in one embodiment, the controller 105 may be operable to communicate with a plurality of computing devices (not shown), each computing device operable to communicate with a respective plurality of gaming devices.

In one or more embodiments, system 100 may include additional devices, such as one or more additional servers (e.g., a hotel reservation server, an entertainment event reservation system, and/or an inventory management server). In accordance with one embodiment, an entertainment event reservation server may comprise, for example, a server storing information regarding tickets purchased for shows affiliated with a casino, information with respect to a time at which an entertainment event starts and/or ends, information with respect to a number of persons attending an entertainment event and/or information identifying players who purchased tickets to an entertainment event. Of course, such information may also be stored at controller 105, as described herein. One or more point-of-sale terminals associated with one or more merchants may also be included in system 100 or be operable to communicate with system 100.

In some embodiments, various casino employees may be equipped with or otherwise utilize one or more casino personnel devices 125, such as personal digital assistants (PDAs) or other computing devices (e.g., personal computer terminals). A casino personnel device 125 may comprise, for example, one or more of various input devices (e.g., a keypad, a touch-sensitive display screen, a card reader, an infrared bar code scanner, etc.), various output devices (e.g., an LCD screen), a processor, a memory and/or a communications port, as described herein with respect to other devices. In some embodiments, a casino personnel device 125 may be operable to communicate with a gaming device, server, kiosk, peripheral device, and/or an inventory/reservation system of a casino-maintained property (e.g., a hotel). Thus, a casino personnel device 125 may be configurable to, among other things, (i) read from and/or write to one or more databases of the present invention, (ii) assist in payments made to players; (iii) “scans” a bar code of a session ticket or cashless gaming receipt to determine a value of a parameter of the session and/or a value associated with the receipt, (iv) validate or authorize redemption of the session ticket and/or receipt; (v) authorize and/or provide payment to a player based on the session ticket and/or receipt; (vi) output an instruction to a casino employee to approach a player and/or intervene with the play of a gaming device by a player; and/or (vii) execute or assist in the execution of various other processes described herein. For example, a casino employee may utilize a casino personnel device 125 to (i) obtain, display and/or view information about a player, (ii) determine a current location of a player, (iii) print a session ticket and/or cashless gaming receipt for a player and/or (iv) determine an offer (e.g., for a session ticket) to provide to a player. In one or more embodiments, a casino personnel device 125 may be operable to read data from and/or write data to one or more of the databases described herein. A memory of a casino personnel device 125 may store a program for executing processes described herein, or portions thereof. In one embodiment, a casino personnel device 125 may be dedicated to facilitating functions of casino personnel with respect to a casino. In another embodiment, a casino personnel device 125 may be a non-dedicated device, such as a cellular telephone, pager and/or PDA.

In some embodiments, various merchants (e.g., bars, ATMs, shops, restaurants, etc.) may utilize point-of-sale (POS) computer terminals to facilitate various processes of the present invention. For example, in some embodiments, a player's activities or behavior (or lack thereof) at a merchant may be utilized to determine whether the player qualifies to receive a session ticket as a promotion. In some embodiments, POS terminals may be configured to read from and/or write to one or more databases of the present invention. Such POS terminals may thus comprise various hardware and software described herein with respect to other devices, and may communicate with (i) a casino server, (ii) a gaming device, (iii) an inventory/reservation system (e.g., a computer terminal at a theatre communicates with an inventory database to determine a number of unsold seats for a certain event), and so on.

In some embodiments, the controller 105 may be operable to communicate with one or more servers of a casino other than the casino associated with controller 105 (e.g., to share information regarding session tickets). In some embodiments, the controller 105 may be operable to communicate with a device and/or entity having information about session tickets and/or sessions.

In some embodiments, various component devices (e.g., any or all of the benefit output devices, output devices, input devices and/or input output devices described herein) may be embodied as peripheral devices. For example, such devices may not necessarily be components of a gaming device or table, though they may be configured in such a manner so as to communicate with one or more gaming device processors, processors associated with table games or processors associated with any other devices described herein. For example, a peripheral device such as a large display device may be associated with a plurality of gaming devices, and thus may not necessarily be considered a component of any one gaming device. Further, in some embodiments, certain peripheral devices such as card readers may be interchangeable between gaming devices, and thus may be considered a component of a first gaming device while connected thereto, removed from the first gaming device, connected to a second gaming device, and so on. In other embodiments, various peripheral devices may never be considered a component of a particular gaming device or table. For example, in some embodiments, a peripheral device such as a USB-based portable memory device may store (i) one or more databases described herein, and/or (ii) a program for executing one or more process steps described herein. Such a peripheral device may then be utilized by casino personnel for upgrading/retrofitting existing gaming devices as described herein.

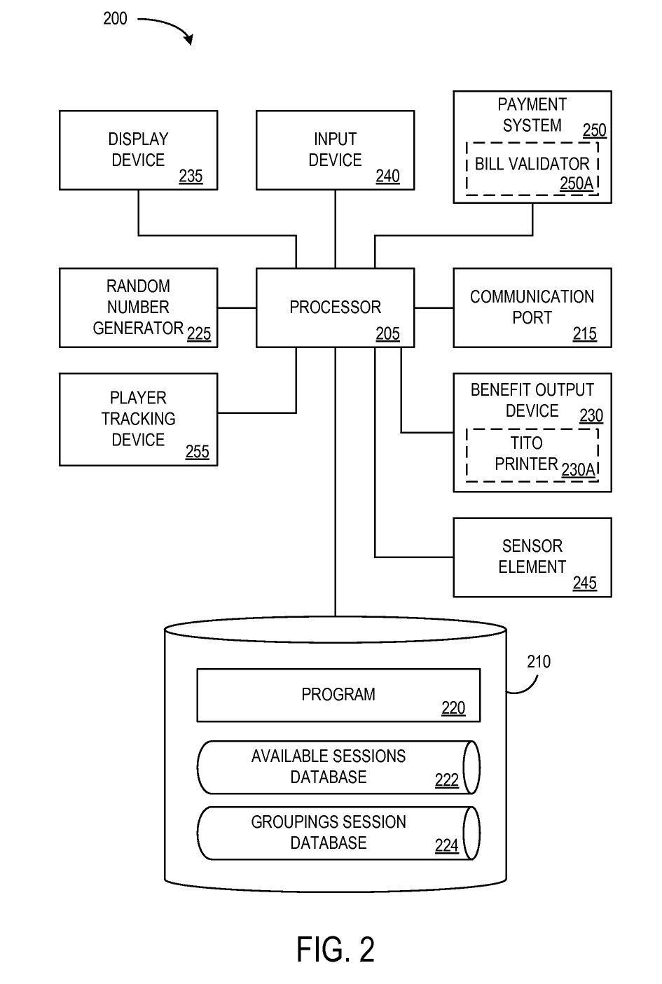

Referring now to FIG. 2, illustrated therein is a block diagram of an embodiment 200 of a gaming device (e.g., a gaming device 110). The embodiment 200 is referred to herein as gaming device 200. The gaming device 200 may be implemented as a system controller, a dedicated hardware circuit, an appropriately programmed general-purpose computer, or any other equivalent electronic, mechanical or electromechanical device. The gaming device 200 may comprise, for example, a slot machine, a video poker terminal, a video blackjack terminal, a video keno terminal, a video lottery terminal, a pachinko machine, a table-top game or a device operable to facilitate a table game. In various embodiments, a gaming device may comprise, for example, a personal computer (e.g., which communicates with an online casino Web site), a telephone (e.g., to communicate with an automated sports book that provides gaming services), or a portable handheld gaming device (e.g., a personal digital assistant or Nintendo GameBoy). In some embodiments, the gaming device 200 may comprise a device operable to facilitate a table game (e.g., a device operable to monitor a blackjack game, such as size or other aspects of a player's wager, side wagers made by a player, cards received and/or decisions made). In some embodiments, a user device such as a PDA or cell phone may be used in place of, or in addition to, some or all of the gaming device 200 components depicted in FIG. 2.

Further, a gaming device 200 may comprise a personal computer or other device operable to communicate with an online casino and facilitate game play at the online casino. In one or more embodiments, the gaming device 200 may comprise a computing device operable to execute software that simulates play of a reeled slot machine game, video poker game, video blackjack game, video keno game, video roulette game, or lottery game. In some embodiments, gaming device 200 may be a dedicated device provided to a casino patron by a casino while in other embodiments it may be a non-dedicated device (e.g., a patron's cellular telephone or PDA).

The example gaming device 200 comprises a processor 205, such as one or more Intel® Pentium® processors. The processor 205 is in communication with a memory 210 and a communication port 215 (e.g., for communicating with one or more other devices, such as with a peripheral device and/or a controller 105). The memory 210 may comprise an appropriate combination of magnetic, optical and/or semiconductor memory, and may include, for example, Random Access Memory (RAM), Read-Only Memory (ROM), a compact disc and/or a hard disk. The memory 210 may comprise or include any type of computer-readable medium. The processor 205 and the memory 210 may each be, for example: (i) located entirely within a single computer or other device; or (ii) connected to each other by a remote communication medium, such as a serial port cable, telephone line or radio frequency transceiver. In one embodiment, the gaming device 200 may comprise one or more devices that are connected to a remote server computer for maintaining databases.

The memory 210 stores a program 220 for controlling the processor 205. The processor 205 performs instructions of the program 220, and thereby operates in accordance with the present invention, and particularly in accordance with the methods described in detail herein. The program 220, as well as any other program for controlling a processor described herein, may be stored in a compressed, uncompiled and/or encrypted format. The following description of program 220 applies equally to all programs for directing a processor described herein. The program 220 furthermore includes program elements that may be necessary, such as an operating system, a database management system and “device drivers” for allowing the processor 205 to interface with computer peripheral devices. Appropriate program elements are known to those skilled in the art, and need not be described in detail herein.

According to an embodiment, the instructions of the program 220 may be read into a main memory from another computer-readable medium, such from a ROM to RAM. Execution of sequences of the instructions in program 220 may cause processor 205 to perform one or more process steps described herein. In alternate embodiments, hard-wired circuitry may be used in place of, or in combination with, software instructions for implementation of the processes of the present invention. Thus, embodiments described herein are not limited to any specific combination of hardware and software.

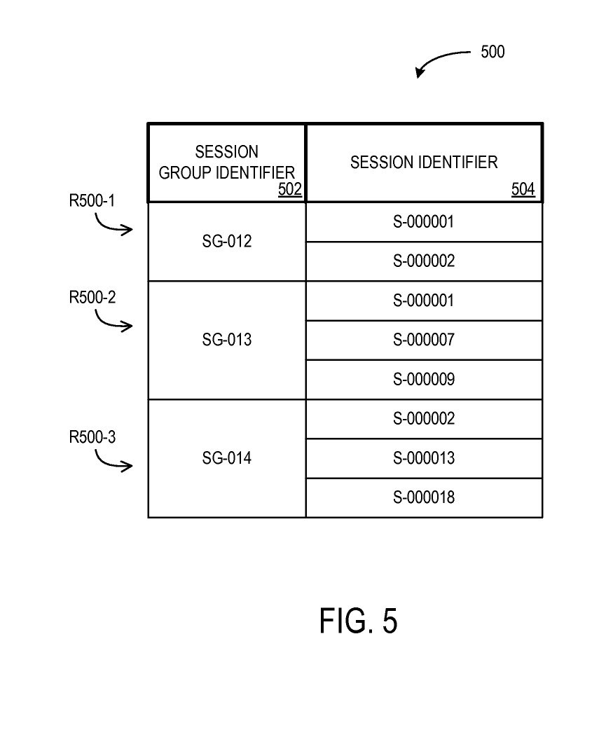

The memory 210 may also store one or more databases. For example, memory 210 may store one or more of an available sessions database 222 and a session groupings database 224. Each of these two databases is described in more detail below with respect to FIG. 4 and FIG. 5, respectively.

The memory 210 may also store one or more probability databases (not shown) and/or one or more payout databases (also not shown). The structure and content of a probability database and of a payout database would be understood by one of ordinary skill in the art and need not be described in detail herein.

In one or more embodiments, as described, data may be stored in a memory of another device (e.g., a database of controller 105 or a database of another server device). In one or more embodiments, gaming device 200 may be operable to access the data thereof or have information associated with the data stored therein downloaded to the gaming device as necessary and/or appropriate. For example, gaming device 200 may access a memory of another device to determine whether a player has previously purchased or otherwise been provided with a session ticket and/or to determine information about a session ticket inserted into a bill validator or other component of the gaming device 200, as described elsewhere herein.

The processor 205 is also operable to communicate with a random number generator 225, which may be a component of gaming device 200. The random number generator 225 (as well as any other random number generator described herein), in accordance with at least one embodiment, may generate data representing random or pseudo-random values (referred to as “random numbers” herein). The random number generator may generate a random number every predetermined unit of time (e.g., every second) or in response to an initiation of a game on the gaming device. In the former embodiment, the generated random numbers may be used as they are generated (e.g., the random number generated at substantially the time of game initiation is used for that game) and/or stored for future use.

A random number generator, as used herein, may be embodied as a processor separate from but working in cooperation with processor 205. Alternatively, a random number generator may be embodied as an algorithm, program component, or software stored in the memory of a gaming device or other device and used to generate a random number.

Note that, although the generation or obtainment of a random number is described herein as involving a random number generator of a gaming device, other methods of determining a random number may be employed. For example, a gaming device owner or operator may obtain sets of random numbers that have been generated by another entity. HotBitS™, for example, is a service that provides random numbers that have been generated by timing successive pairs of radioactive decays detected by a Geiger-Muller tube interfaced to a computer. A blower mechanism that uses physical balls with numbers thereon may be used to determine a random number by randomly selecting one of the balls and determining the number thereof.

The processor 205 is also operable to communicate with a benefit output device 230, which may be a component of gaming device 200. The benefit output device 230 may comprise one or more devices for outputting a benefit or representation of a benefit to a player of the gaming device 200. For example, in one embodiment the gaming device 200 may provide coins and/or tokens as a benefit. In such an embodiment the benefit output device 230 may comprise a hopper and hopper controller, for dispensing coins and/or tokens into a coin tray of the gaming device 200.

In another example, the gaming device 200 may provide a receipt or other document on which there is printed an indication of a benefit (e.g., a cashless gaming receipt that has printed thereon a monetary value, which is redeemable for cash in the amount of the monetary value). In such an embodiment the benefit output device 230 may comprise a printing and document dispensing mechanism, such as printer 230A. In the embodiments described herein, the printer 230A may print a session ticket for a player

In yet another example, the gaming device 200 may provide electronic credits as a benefit (which, e.g., may be subsequently converted to coins and/or tokens and dispensed from a hopper into a coin tray). In such an embodiment the benefit output device 230 may comprise a credit meter balance, credit meter balance display and/or a processor that manages the amount of electronic credits that is indicated on a display of a credit meter balance. Such a processor may be the processor 205 or another processor. In yet another example, the gaming device 200 may credit a monetary amount to a financial account associated with a player as a benefit provided to a player. The financial account may be, for example, a credit card account, a debit account, a charge account, a checking account, and/or a casino account. In such an embodiment the benefit output device 230 may comprise a device for communicating with a server on which the financial account is maintained.

Note that, in one or more embodiments, the gaming device 200 may include more than one benefit output device 230 even though only one benefit output device is illustrated in FIG. 2. For example, the gaming device 200 may include a printer for printing a session ticket and a credit meter balance display. Such a gaming device may be operable to provide more than one type of benefit to a player of the gaming device (e.g., both cash and a session ticket). A single benefit output device 230 may be operable to output more than one type of benefit. For example, a benefit output device 230 may be operable to print either a cashless gaming receipt redeemable for cash and a session ticket redeemable for a session (in some embodiments a session ticket may also be redeemable for cash).

The processor 205 is also operable to communicate with a display device 235, which may be a component of gaming device 200. The display device 235 may comprise, for example, one or more display screens or areas for outputting information related to game play on the gaming device, such as a cathode ray tube (CRT) monitor, liquid crystal display (LCD) screen, or light emitting diode (LED) screen.

In one or more embodiments, a gaming device 200 may comprise more than one display device 235. For example, a gaming device 200 may comprise an LCD display for displaying electronic reels and a display device that comprises a viewing window behind which are located mechanical reels and which displays the rotation of the mechanical reels during game play.

In one embodiment, a display device 235 may be operable to display a message to a player. For example, a message informing a player of his progress in a session may be output. Such a message may, for example, present the player with an offer for a session ticket redeemable for another session.

The processor 205 may also be in communication with one or more other devices besides the display device 235, for outputting information (e.g., to a player or another device). Such other one or more output devices may also be components of gaming device 200. Such other one or more output devices may comprise, for example, an audio speaker (e.g., for outputting a message to a player, such as a message informing the player of his progress in a session, in addition to or in lieu of such a message being output via a display device 235), an infra-red transmitter, a radio transmitter, an electric motor, a printer (e.g., such as for printing session tickets and/or cashless gaming vouchers), a coupon or product dispenser, an infra-red port (e.g., for communicating with a second gaming device or a portable device of a player), a Braille computer monitor, and a coin or bill dispenser. For gaming devices, common output devices include a cathode ray tube (CRT) monitor on a video poker machine, a bell on a gaming device (e.g., rings when a player wins), an LED display of a player's credit balance on a gaming device, an LCD display of a personal digital assistant (PDA) for displaying keno numbers.

The display device 235 may comprise, for example, one or more distinct display areas and/or one or more distinct display devices. For example, one of the display areas may display outcomes of games played on the gaming device (e.g., electronic reels of a gaming device). Another of the display areas may display rules for playing a game of the gaming device. Yet another of the display areas may display the benefits obtainable by playing a game of the gaming device (e.g., in the form of a payout table). Yet another of the display areas may display information related to a session the player is engaged in (e.g., a value for a parameter of a session, such as number of hands remaining in a video poker session). In one or more embodiments, the gaming device 200 may include more than one display device, one or more other output devices, or a combination thereof (e.g., two display devices and two audio speakers).

The processor 205 is also in communication with an input device 240, which is a device that is capable of receiving an input (e.g., from a player or another device) and which may be a component of gaming device 200. An input device may communicate with or be part of another device (e.g. a server, a gaming device, etc.). Some examples of input devices include: a bar-code scanner, a magnetic stripe reader, a computer keyboard or keypad, a button (e.g., mechanical, electromechanical or “soft”, as in a portion of a touch-screen), a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port (e.g., for receiving communications from with a second gaming device or a another device such as a smart card or PDA of a player), and a weight scale. For gaming devices, common input devices include a button or touch screen on a video poker machine, a lever or handle connected to the gaming device, a magnetic stripe reader to read a player tracking card inserted into a gaming device, a touch screen for input of player selections during game play, and a coin and bill acceptor/validator (which may be operable to receive and read information from a session ticket and which may also qualify as a payment system, described below). Input device 240 may comprise any of the above-described input device or any combination thereof (i.e., input device 240 may comprise more than one input device).

In some embodiments, a gaming device 200 may comprise components capable of facilitating both input and output functions (i.e., input/output devices). In one example, a touch-sensitive display screen comprises an input/output device (e.g., the device outputs graphics and receives selections from players). In another example, a processor may communicate with a “ticket-in/ticket-out” (TITO) device configured to dispense and receive cash-out tickets and session tickets. Such a device may also assist in (e.g., provide data so as to facilitate) various accounting functions (e.g., ticket validation and redemption). For example, any or all of a gaming device, kiosk and casino personnel device maintained at a cashier cage may (i) comprise such a benefit input/output device, and/or (ii) communicate with a central server that manages the accounting associated with such TITO transactions (e.g., so as to track the issuance, redemption and expiration of such tickets). One example of TITO technology that may be adapted or utilized to implement embodiments described herein is the EZ Pay™ system, is manufactured by IGT™, headquartered in Reno, Nev.

As is described in more detail below with respect to processes consistent with embodiments of the present invention, in one embodiment a gaming device 200 may be operable to receive, via a TITO system, a session ticket. Such a gaming device may further be operable to communicate with a server to validate the session ticket based on information read from the session ticket, receive information from the server regarding the session(s) associated with the session ticket and configure the gaming device based on the received information.

Of course, as would be understood by one of ordinary skill in the art, a gaming device 200 may comprise various combinations of any or all of the component devices described herein. For example, in one or more embodiments, the gaming device may include more than one display device, one or more other output devices, several input devices, and so on (e.g., two display screens, two audio speakers, a headset, a TITO device and several buttons).

One example of a particular input device 240 that may be a component of gaming device 200 is a sensor element 245. A sensor element 245 may be a component of gaming device 200 or may be otherwise associated with gaming device 200 (and, e.g., be operable to provide information to gaming device 200). A sensor element 245 may comprise any device or combination of devices operable to detect, receive an indication of, measure, determine, and/or deduce (i) a change in a parameter, (ii) a value of a parameter, and/or (iii) a state of a device and/or parameter. In particular, in some embodiments a sensor element 245 may comprise an element, component, device, mechanism or other means for sensing information associated with a player playing the gaming device 200. For example, a sensor element 245 may comprise one or more of the following: (i) a pressure or weight sensor in a seat associated with the gaming device 200, operable to determine when someone has sat in the seat and gotten up from the seat; (ii) a sensor associated with one or more buttons (or a plurality of sensors, each sensor associated with a respective button) of the gaming device 200, operable to determine when the one or more buttons have been actuated, even if at the time of actuation the one or more buttons are in an inactive state; (iii) a tilt and/or shake sensor operable to determine when the gaming device 200 has been tilted or shaken; (iv) one or more pressure sensors in or on the cabinet housing of the gaming device 200, operable to determine when the gaming device 200 has been struck or hit; (v) a camera for capturing images and/or analyzing images (e.g., an expression of a player, an eye position of the player, a change in expression and/or eye position of a player); (vi) a microphone operable to determine a sound uttered by a player; and (vii) a sensor for determining an amount of currency provided to the gaming device.

Information from a sensor element may be utilized, for example, to determine whether an offer for a new session or an extension of a session, or a modification to a value of a parameter of a session should be provided to a player. For example, based on words uttered by a player and/or an increase in the pressure with which a player is actuating a button of the gaming device, it may be determined that the player is very excited towards the end of a session and may be likely to accept an offer for an extension of the session.

The processor 205 is also in communication with a payment system 250, which may be a component of gaming device 200. The payment system 250 is a device capable of accepting payment from a player (e.g., a bet or initiation of a balance) and/or providing payment to a player (e.g., a payout). Payment is not limited to currency, but may also include other types of consideration, including products, services, and alternate currencies. Payment system 250 may be considered to be an example of an input device 240 in some embodiments.

Exemplary methods of accepting payment by the payment system 250 include (i) receiving hard currency (i.e., coins or bills), and accordingly the payment system 250 may comprise a coin or bill acceptor; (ii) receiving an alternate currency (e.g., a session ticket, other cashless gaming voucher, a coupon, a non-negotiable token), and accordingly the payment system 250 may comprise a bar code reader or other sensing means; (iii) receiving another type of payment identifier (e.g., a credit card number, a debit card number, a player tracking card number) and debiting an account identified by the payment identifier; and (iv) determining that a player has performed a value-added activity.

Processor 205 may also be in communication with a player tracking device 255, which may be a component of gaming device 200. Player tracking device 255 may, in some embodiments, be considered an example of an input device 240. Player tracking device 255 may, in one or more embodiments, comprise a reader device operable to read information from and/or write information to a card such as a smart card and/or a player tracking card, such that (i) players may be identified, and (ii) various data associated with players may then be determined. For example, session ticket(s) associated with a player, previous wagering, coin-in and/or cash-out behaviors previously engaged in by the player may be determined based on information associated with the player identifier. In another example, previous strategies employed in a video poker game may be similarly determined. In yet another example, a rating or other categorization of a player may be determined for purposes of determining which session(s) a player qualifies to purchase and/or redeem. For example, in one embodiment if the player is categorized in a certain category, the player may in some embodiments be allowed to redeem a particular session ticket for a particular session, or receive the benefit of a particular value for a particular parameter within his session, that the player would not otherwise be allowed to redeem the session ticket for. In yet another example, a player may only be allowed to select a particular session, or a particular value of a particular parameter of a session, if the player qualifies for such via a categorization of the player.

In yet another example, a session ticket inserted into gaming device 200 may only be validated and authorized for redemption if a player tracking card associated with the session ticket is inserted into gaming device 200 at the time of ticket validation. In other words, a session ticket provided to a player may only be redeemable in conjunction with a particular player identifier, player card identifier and/or player. Accordingly, the player identifier from a player tracking card as determined by a player tracking device 255 may be transmitted to a server along with a session ticket identifier as determined by a TITO device of the gaming device.

Thus, in one or more embodiments, a gaming device 200 via a player tracking device 255 may be operable to determine an identifier associated with a player (e.g., by reading a player tracking card comprising an encoded version of the identifier), such that the gaming device may then access data (e.g., of a player database, a session database, a ticket session database) associated with the player. In another example, a smart card reader device may determine data associated with a player directly by accessing a memory of an inserted smart card.

Although not shown, it should be noted that a gaming device may store or access (if such is stored on another device) a player database. A player database may be used, for example, to store session ticket data associated with a player, player wager data (e.g., such that players wagering over a given threshold in a given amount of time may be rewarded for their patronage, qualify for certain features or sessions, etc.). The player database may also contain other information that may be useful in, for example, promoting and managing player behaviors (e.g., information about the player's gaming preferences, session preferences, available and/or redeemed sessions, lodging arrangements, and the like). Further, the player database may store data regarding a given player's standing in a game session and/or a bonus game. Such player data may be stored in a relational database and retrieved or otherwise accessed by the processor after receiving a “key” data point from the player, such as a unique identifier read from the player's player tracking card, session ticket or cashout ticket.

In one embodiment, the player tracking device 255 may comprise (i) a card reader (e.g., a port into which player tracking cards may be inserted), (ii) various input devices (e.g., a keypad, a touch-screen), (iii) various output devices (e.g., a small, full-color display screen), and/or (iv) combinations thereof (e.g., a touch-sensitive display screen that accommodates both input and output functions). Various commercially available devices may be suitable for such an application, such as the NextGen™ interactive player tracking panel manufactured by IGT™ or the iVIEW™ display screen manufactured by Bally® Gaming and Systems.

As known in the art, “smart cards” may incorporate (i) a memory, and (ii) means for accessing such a memory. For example, in one embodiment, the memory may store data related to aspects of the present invention. In one embodiment, data may be written to the smart card as a player plays one or more gaming devices (e.g., such that various data may be updated on a continuous, periodic or event-triggered bases). Accordingly, in one or more embodiments one or more devices operable to carry out various processes of the present invention (e.g., a gaming device 200 or controller 105) may have associated therewith a smart card reader device, such that data may be read from the smart card pursuant to the execution of such processes. An example of a smart card system that may be used to implement one or more embodiments of the present invention is the s-Choice™ Smart Card Casino Management System from Smart Card Integrators, Inc™. For example, a smart card may store thereon one or more indications (e.g., identifiers) of a session ticket purchased by or otherwise provided to a player and/or data defining one or more sessions associated with such a session ticket (e.g., duration, maximum wager, game, retail price, session identifier, etc.).

Of course, other non-card-based methods of identifying players are contemplated. For example, a unique identification code may be associated with the player. The player may then be identified upon entering the code. For example, the code may be stored (e.g., within a database maintained within a gaming device 200 or controller 105) such that the player may enter the code using an input device of a gaming device, and accordingly allow the player to be uniquely identified. In other embodiments, player biometrics may serve as identification means (e.g., a player is identified via a thumbprint or retinal scan of the player). In further embodiments, a barcode of a session ticket or a cashless gaming ticket may encode a player identifier.

Thus, as described, various data associated with a player may be tracked and stored (e.g., in an appropriate record of a centrally-maintained database), such that it may be accessed as desired (e.g., when determining whether to authorize redemption of a session ticket inserted into gaming device 200). Further, various statistics may be measured in association with a player (e.g., coin-in statistics, win/loss statistics, buy-in amount for a session, success in a session, final credit balance of a session, current status in a session, etc.) and similarly accessed.

Various systems for facilitating such monitoring of player behavior and activity are contemplated. For example, a two-wire system such as one offered by International Gaming Systems (IGT) may be used. Similarly, a protocol such as the IGT SAS™ protocol or the IGT SuperSAS™ protocol may be used. The SAS™ protocol and the SuperSAS™ protocol each allows for communication between gaming machines and slot accounting systems and provides a secure method of communicating all necessary data supplied by the gaming device to the online monitoring system. One aspect of the SAS™ protocol and the SuperSAS™ protocol that may be beneficial in implementing aspects of the present invention is the authentication function which allows operators and regulators to remotely interrogate gaming devices for important memory verification information, for both game programs, and peripheral devices. In another example, a one-wire system such as the OASIS™ System offered by Aristocrat Technologies™ or the SDS slot-floor monitoring system offered by Bally Gaming and Systems™ may be used. Each of the systems described above is an integrated information system that continually monitors slot machines and customer gaming activity. Thus, for example, any one of these systems may be used to monitor a player's gaming activity in order to determine session or session ticket status (e.g., has a particular session ticket been redeemed), player outcomes, session buy-in amounts (e.g., the retail price paid for a session or the starting credit balance for a session), coin-in statistics, win/loss statistics and/or any other data deemed relevant.

In one embodiment, a player may operate a plurality of gaming devices. For example, a player may simultaneously play two side-by-side gaming devices, a player may play one gaming device (e.g. a reeled slot machine) and then continue his gaming session at another gaming device (e.g. a video poker machine), and a player may remotely operate a gaming device, possibly by using a telephone, PDA or other device (i) to transmit commands (directly or indirectly) to the gaming device, such as wager amounts and commands to select certain cards; and/or (ii) to receive output (directly or indirectly) from the gaming device.

In one embodiment, a gaming device may allow a player to play a game of skill rather than a game of chance. Such an embodiment may be more appealing to certain players or may be permitted in areas where it is illegal to gamble on games of chance.

In another embodiment, a gaming device may facilitate a player playing a table game (e.g., the gaming device may comprise a device associated with the player's position at a table game which allows the player to purchase and/or redeem a session via a session ticket). In the latter example, if a player redeems a session at a table game by inserting the session ticket into the gaming device associated with the player's position at a table game, the gaming device may communicate some or all of the information of the session and/or an indication that the player is going to participate in a session, to the dealer (e.g., by communicating with a device associated with the dealer of the table, should the table have a live dealer). In smart table embodiments in which the dealer employs a virtual dealer rather than a live dealer or no dealer is present at all, the gaming device may comprise the smart table and the player's redemption of the session ticket at a table may be communicated to a processor facilitating the table game and may be reflected by a virtual dealer facilitating the table game and thus the session.

In one embodiment, a live dealer collects a session ticket and configures a player to begin session play (e.g., provides chips, a counter for a number of hands, etc.). Various methods for facilitating session play at a table game such as blackjack are described in Applicant's co-pending U.S. Provisional Patent No. 60/949,962, filed Jul. 16, 2007. This Application is incorporated by reference for all purposes.

In one embodiment, gaming device 200 may be operable to facilitate downloadable games such that games available for play on gaming device 200 may be stored on a server device (e.g., controller 105 or another device) and downloaded to the gaming device 200. In one embodiment, software components of the gaming device 200 may be remotely modified and/or updated by another device (e.g., controller 105 or another device). For example, a payout or probability table stored in the memory of gaming device 200 may be altered, modified or updated remotely, hot fixes may be applied to software stored by the gaming device 200 and/or new versions of software may be downloaded to the gaming device 200. Similarly, the gaming device 200 may be programmed to retrieve any or all such updates from another device, as appropriate and preferred. Any of the above (e.g., downloading of a game, updating of software, modification of a payout or probability table) may occur, for example, based upon an occurrence of an event (e.g., a scheduled event), an indication being received from qualified casino personnel or other personnel (e.g., a regulator), and/or upon a request from a player. In one embodiment, gaming device 200 may comprise a thin client device controlled be a server device (e.g., controller 105 or another device).

In one or more embodiments, aspects of the present invention, such as selling, providing, printing, determining, authorizing, validating and/or redeeming a session ticket and/or configuring a gaming device based on a session ticket, may be practiced by replacing and/or augmenting one or more components (e.g., hardware and/or software components) of an existing gaming device. Thus, in one or more embodiments, the invention may be applied as a retrofit or upgrade to existing gaming devices currently available for play within various casinos.

For example, a memory (e.g., computer chip) of the gaming device may be replaced or added, the replacement or additional memory storing a program for instructing the processor of the gaming device to operate in accordance with one or more embodiments. In another example, data output via the gaming device (e.g., graphical and/or textual data displayed on the gaming device) may be replaced or added, the replacement or additional data indicating to a player information relevant to one or more aspects of the present invention. For example, the glass of the gaming device may be modified or replaced to reflect that the gaming device is now operable to facilitate session play and accept session tickets.

In a specific example, a gaming device may comprise various electronic components mounted to one or more printed circuit boards (PCBs). Such components may include various hardware described herein, such as a communications port and various controllers of peripheral devices (e.g., a display controller), as well as a memory for storing programming instructions (software) and a processor for carrying out such instructions. Forms of memory that may be found in a gaming device include electronically erasable programmable read-only memory (EEPROM), erasable programmable read-only memory (EPROM) and flash memory. Thus, in one or more embodiments of the present invention, an EPROM storing software with instructions for carrying out aspects of the present invention (as well as instructions for carrying out other functions traditionally performed by the gaming device) may replace an EPROM previously installed in a gaming device or may be reprogrammed in accordance with one or more embodiments described herein, such that the gaming device may be configured to operate in accordance with various processes described herein.

For example, an EPROM or EEPROM chip having various available sessions or groups of sessions, and the values of the parameters of each of such sessions, may be added to a gaming device or replace an existing chip in a gaming device. Of course, in download-enabled gaming devices to which new games, instructions, features and/or capabilities may be downloaded from a remote server device (e.g., controller 105), replacement of such a chip may not be necessary and/or desired.

In one embodiment, a “session ticket” module may be made available for purchase to various casino operators. The module, which may comprise various hardware and software (e.g., an EPROM storing software instructions and data defining one or more sessions), may be installed in an existing gaming device (e.g., a video-reel slot machine, a video poker machine, a table game device, etc.), such that when the module is installed, players of the device may elect (i) to play the gaming device in a manner that does not incorporate embodiments described herein, or (ii) to play the gaming device in a manner that incorporates embodiments described herein (e.g., be able to redeem a session by inserting a session ticket into the gaming device). Thus, players who are familiar with operating a gaming device may elect to pay for them in a different or similar manner as they are accustomed to.

Similarly, in addition to or in lieu of a player being able to select a mode of operation of the gaming device, in some embodiments a casino operator may be able to do so. For example, a casino operator may be able to select whether the gaming device is to operate in a conventional mode or in a “problem gambler identification” mode.

Accordingly, a gaming device may be configured to allow a player, casino operator or other entity to select one of at least two “modes” of the gaming device, and to enable the selected mode. If a “standard” mode is selected, the gaming device may be configured to operate in a manner similar to how it operated before the installation of the module (e.g., the gaming device operates in a conventional manner, such that game plays may be purchased one at a time). If a “session play” mode is selected, the gaming device may then be operable to execute game play in accordance with one or more embodiments described herein (e.g., allow purchase of blocks of play at a time, at a discounted price from the price the player would otherwise pay for the game plays in the block if the player were to purchase them one at a time; allow initiation of session based on session ticket).

In one example of allowing an entity to select one or more modes, a touch-sensitive display screen may be configured to output a prompt to select a mode of operation. Such a prompt may be output in occurrence to various trigger conditions (e.g., coins, bills or tickets (e.g., session ticket) are inserted; a credit balance increases from zero to some other number; a player presses a “play” button; a motion, weight, infrared or other sensor detects the presence of a player; the gaming device being turned on, initiated, re-configured and/or rebooted, etc.). Accordingly, an entity may select a mode of operation (e.g., by pressing an appropriately labeled icon of a touch-sensitive display screen), and upon receiving the entity's selection, the gaming device may be configured to operate in the selected mode.

In another embodiment, a gaming device may be operable to automatically determine whether it should switch modes from a standard mode to a “session play” mode. A gaming device may perform such a determination, for example, by evaluating data received from a player and/or another device and/or by querying another device. For example, a gaming device may be programmed to determine (e.g., upon receiving a player identifier and based upon the player identifier) whether the player prefers to play the gaming device in session play mode. In another example, the gaming device may enter a session play mode automatically upon receiving a session ticket into its TITO device. In some embodiments, the gaming device may be programmed to automatically configure itself to a particular session based on information associated with a session ticket that is inserted into the gaming device, as described in more detail below.

In one embodiment, a gaming device may be operable to output an indication that it is currently in “session play” mode. For example, the gaming device may turn on a light, change graphics, output a sound, etc.

In other embodiments, as described herein, a peripheral device may be useful for implementing one or more embodiments of the present invention into the operation of a conventional gaming device. For example, in order to avoid or minimize the necessity of modifying or replacing a program already stored in a memory of a conventional gaming device, an external or internal module that comprises a peripheral device may be inserted in, connected to or otherwise associated with the gaming device. Such a peripheral device may be operable to, for example, monitor and/or transmit information about a player's gambling activity at the gaming device to another device (e.g., controller 105). The peripheral device may monitor and/or transmit such information to enable a determination of whether a player qualifies to receive or redeem a session ticket and may even be operable to print such a session ticket.

In still further embodiments, as described above, rather than configure existing gaming devices to execute embodiments described herein by installing or connecting new hardware and/or software, software may be downloaded into an existing memory of one or more gaming devices. U.S. Pat. No. 6,805,634 to Wells et al. teaches methods for downloading data to gaming devices in such a manner. The entirety of U.S. Pat. No. 6,805,634 is incorporated by reference herein for all purposes. Thus, in some embodiments, an existing gaming device may be reprogrammed to accommodate new functionality of the present invention without the need, or by minimizing the need, to remove and replace hardware within the gaming device.

In one embodiment, a gaming device 200 or another device (e.g., a kiosk) operable to carry out one or more embodiments described herein may be operable to output a menu of available sessions to a player via a player interface. A player interface may comprise, for example, a video screen that is a touch screen operable to display such one or more such menus. A menu so displayed to a player may provide the player with, for example, a choice of sessions for which a session ticket may be redeemed and/or a choice of sessions which may be purchased via a session ticket. A player may be presented with a menu of options via a touch screen, for example, upon inserting a session ticket for redemption, upon indicating a desire to consider options available via such a menu and/or upon initiating play at the gaming device 200. A player may select an option from such a menu by touching the area of the screen on which the option appears.

It should be appreciated that one or more embodiments may include storing graphic and/or sound elements that are used to construct the menu of available options. These elements may be store, for example, in EPROM, EEPROM, flash memory, hard disk, CD ROM, or in any other suitable storage device. The menu may be displayed via any suitable display device, such as a CRT, LCD, VFC, LED display. In one embodiment, the menu may be implemented using only dedicated electromechanical switches. In one embodiment, a player operates an input device of the device operable to display the menu, in order to cause the menu to be displayed. In one embodiment, the device includes a touch screen and a touch screen controller (not shown) associated with a video monitor display device. The touch screen and touch screen controller may be operable to communicate with a video controller of the video monitor display device and a processor (e.g., a processor of gaming device 200). Thus, a player may be enabled to indicate decisions (e.g., which session to redeem a session ticket for, which session to purchase, configure values of parameters to customize a session, etc.) by touching the touch screen in the appropriate places.

In one embodiment, display of the menu preempts display of other information. For example, in one embodiment the same display device or screen used to display indicia indicative of an outcome by displaying the indicia as disposed along a payline during active game play may be used to display a menu of available sessions to a player upon an indication of a player to view the menu. In another embodiment, a dedicated display device or screen may be used to display a menu of available sessions on a continuous, periodic, or other basis.

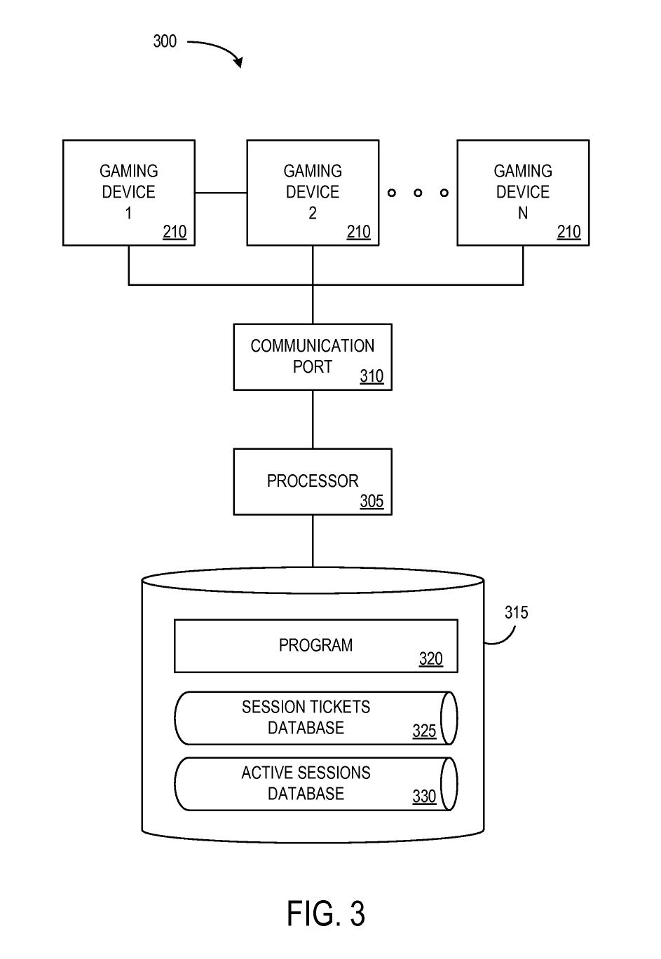

Referring now to FIG. 3, illustrated therein is an embodiment 300 of a controller operable to communicate with one or more gaming devices 200. Although three gaming devices 200 are illustrated, any number may be used. A gaming device 200 may comprise, for example, a gaming device 110 and/or the gaming device 200 of FIG. 2. The embodiment 300 may be, for example, an embodiment of the controller 105. Embodiment 300 is referred to as controller 300 herein. It should be noted that controller 300 may comprise a server device operable to communicate with one or more gaming devices, as the term is used herein.

The controller 300 may be implemented as a system controller, a dedicated hardware circuit, an appropriately programmed general-purpose computer, or any other equivalent electronic, mechanical or electromechanical device. The controller 300 may comprise, for example, one or more server computers operable to communicate with one or more client devices, such as one or more gaming devices, one or more kiosks, one or more peripheral devices, and/or one or more casino personnel devices. The controller 300 may be operative to manage all or part of the system 100 and to execute some or all of the methods described herein.

In operation, the controller 300 may function under the control of a casino, another merchant, or other entity that may also control use of the gaming devices 110 (e.g., a regulatory agency). For example, the controller 300 may be a slot server in a casino. In some embodiments, the controller 300 and a slot server may be different devices. In some embodiments, the controller 300 may comprise a plurality of computers operating together. In some embodiments, the controller 300 and a gaming device may be the same device.

The controller 300 comprises a processor 305, such as one or more Intel® Pentium® processors. The processor 305 is in communication with a communication port 310 (e.g., for communicating with one or more other devices, such as one or more gaming devices 200) and a memory 315. The memory 315 may comprise an appropriate combination of magnetic, optical and/or semiconductor memory, and may include, for example, Random Access Memory (RAM), Read-Only Memory (ROM), a compact disc and/or a hard disk. The processor 305 and the memory 315 may each be, for example: (i) located entirely within a single computer or other device; or (ii) connected to each other by a remote communication medium, such as a serial port cable, telephone line or radio frequency transceiver. In one embodiment, the controller 300 may comprise one or more devices that are connected to a remote server computer for maintaining databases.

The memory 315 stores a program 320 for controlling the processor 305. The processor 305 performs instructions of the program 320, and thereby operates in accordance with the present invention, and particularly in accordance with the methods described in detail herein. The program 320 may be stored in a compressed, uncompiled and/or encrypted format. The program 320 furthermore includes program elements that may be necessary, such as an operating system, a database management system and “device drivers” for allowing the processor 305 to interface with computer peripheral devices. Appropriate program elements are known to those skilled in the art, and need not be described in detail herein. The program 320 may include computer program code that allows the controller 300 to employ the communication port 310 to communicate with a gaming device (e.g., gaming device 200) in order to, for example:
1. track session tickets available for purchase or other provision to players;
2. track session tickets issued (i.e., purchased by or otherwise provided) to players;
3. track validation, authorization and/or redemption of session tickets (e.g., an requests for any of the above from gaming devices);
4. instruct a gaming device to perform one or more functions (e.g., configure itself for a particular session, authorize initiation of a session, print a session ticket, output a message to a player, interrupt play, modify a session currently in progress, etc.);
5. identify a player currently playing a gaming device;
6. determine current and/or predicted utilization of one or more gaming devices;
7. receive an input from a casino employee;
8. controlling (e.g., preventing or regulating) access to stored funds and/or a credit line; and/or
9. communicate with one or more other controllers (e.g., an entertainment event database, a hotel reservation database) to determine information.
10. Command the gaming device to print out a session ticket (such as a “suspend play” session ticket which would allow a player to later resume a session already begun, etc.).

According to an embodiment, the instructions of the program 320 may be read into a main memory from another computer-readable medium, such from a ROM to RAM. Execution of sequences of the instructions in program 320 causes processor 305 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

The memory 315 also stores (i) a tickets database 325 and (ii) an active sessions database 330. Each of the databases 325 and 330 is described in more detail below.

In some embodiments (e.g., in an embodiment in which controller 300 manages downloadable games playable on one or more gaming devices), the memory 315 may store additional databases. Examples of such additional databases include, but are not limited to, (i) a gaming device database that stores information (e.g., current utilization or other status) related to one or more gaming devices with which the controller 300 is operable to communicate, (ii) a game database that stores information regarding one or more games playable on and/or downloadable to one or more gaming devices, and (iii) a scheduling and/or configuration database useful for determining which games and/or sessions are to be made available on which gaming devices at which time(s).

Similarly, in one embodiment controller 300 may be operable to configure a gaming device remotely, update software stored on a gaming device and/or to download software or software components to a gaming device. For example, controller 300 may be operable to apply a hot fix to software stored on a gaming device, modify a payout and/or probability table stored on a gaming device and/or transmit a new version of software and/or a software component to a gaming device. For example, controller 300 may communicate information regarding new sessions or session tickets and/or modifications to already available sessions or session tickets to a gaming device. Controller 300 may be programmed to perform any or all of the above functions based on, for example, an occurrence of an event (e.g., a scheduled event), receiving an indication from a qualified casino employee and/or other person (e.g., a regulator) and/or receiving a request from a player.

Although the databases 325 and 330 are described as being stored in a memory of controller 300, in other embodiments some or all of these databases may be partially or wholly stored, in lieu of or in addition to being stored in a memory of controller 300, in a memory of one or more other devices. Such one or more other devices may comprise, for example, one or more peripheral devices, one or more gaming devices, a slot server (if different from the controller 300), another device, or a combination thereof. Further, some or all of the data described as being stored in the memory 315 may be partially or wholly stored (in addition to or in lieu of being stored in the memory 315) in a memory of one or more other devices. Such one or more other devices may comprise, for example, one or more peripheral devices, one or more gaming devices, a slot server (if different from controller 300), another device, or a combination thereof.

Various databases that may be useful in one or more embodiments will now be described. Example structures and sample contents of the (i) an available sessions database 222; (ii) a session groupings database 224; (iii) a tickets database 325; and (iv) an active sessions database 330 are shown in FIGS. 4-7, respectively. The specific data and fields illustrated in these drawings represent only some embodiments of the records stored in the databases described herein. The data and fields of these databases can be readily modified, for example, to include more or fewer data fields. A single database may also be employed. Note that in the databases, a different reference numeral is employed to identify each field of each database. However, in at least one embodiment, fields that are similarly named (e.g., player identifier fields) may store similar or the same data in a similar or in the same data format.

Example embodiments of the databases 222, 224, 325 and 330 are described in detail below and example structures are depicted with sample entries in the accompanying figures. As will be understood by those skilled in the art, the schematic illustrations and accompanying descriptions of the sample databases presented herein are exemplary arrangements for stored representations of information. Any number of other arrangements may be employed besides those suggested by the tables shown. For example, even though four separate databases are illustrated, the invention could be practiced effectively using one, two, three, five or more functionally equivalent databases. Similarly, the illustrated entries of the databases represent exemplary information only; those skilled in the art will understand that the number and content of the entries can be different from those illustrated herein. Further, despite the depiction of the databases as tables, an object-based model could be used to store and manipulate the data types of the present invention and likewise, object methods or behaviors can be used to implement the processes of the present invention. Similarly, a hierarchical electronic file system model could be used to store and access some or all of the data depicted in the databases.

It should also be noted that some or all of the data or types of data illustrated in FIGS. 4-7 may be stored and managed in individual ones of the gaming devices 110 and may be used therein to manage, control and/or monitor events at the one or more gaming devices.

Referring now to FIG. 4, illustrated therein is a tabular representation of an example embodiment 400 of an available sessions database 222. Embodiment 400 is referred to as available sessions database 400 herein. An available sessions database 400 may be stored in a memory of a device (e.g., memory 315 of controller 300 and/or memory 210 of gaming device 200) in tabular form, or any other appropriate database form, as is well known in the art. The data stored therein may include a number of exemplary records or entries, including records R400-1 through R400-7, each defining a session that may be available for sale or other provision to a player. Those skilled in the art will understand that the available sessions database 400 may include any number of entries.

The available sessions database 400 also defines fields for each of the entries or records. The fields specify: (i) a session identifier 402 (e.g., a unique identifier in alphanumeric form that identifies a session as defined by the corresponding record); (ii) a starting credit balance 404 that defines the number of credits the session credit balance will be set to upon initiation of the corresponding session; (iii) a duration 406 of the corresponding session (e.g., this field may specify the event the occurrence of which will cause the corresponding session to end); (iv) a game type 408 which specifies the game(s) for which the session may be redeemed (e.g., this field may store a unique identifier corresponding to a game(s) or a name of a game, such as Little Green Men™; in other embodiments this field may store an indication of a class of games or one or more characteristics of game(s) for which the corresponding session may be redeemed (e.g., video reels, video poker, progressive, 5 payline, etc.); (v) active pay combos 410 which specify a paytable to be used during the session (it should be noted that in other embodiments this field may list one or more payout combinations that are to be active or deactivated during the session); (vi) a denomination 412 for wagers to be used during the session (it should be noted that this field may also be used to denote a characteristic of a gaming device on which the corresponding session is valid, such as a $0.05 machine); (vii) a wager per game play 514 that defines the number of units of the denomination of field 412 to be placed on each game play of the corresponding session (as noted above, in some embodiments this amount may be variable throughout the session based on, for example, player selection, current credit balance, duration of session remaining, and/or another factor); and (viii) a price 416 associated with the corresponding session (e.g., a retail price for which the session is sold (which in some cases may be discounted for a particular player). With respect to (viii), the interested reader is referred to commonly-owned U.S. application Ser. No. 11/270,016, filed Nov. 9, 2005 in the name of Walker et al. and entitled SYSTEMS, METHODS AND APPARATUS FOR FACILITATING A FLAT RATE PLAY SESSION ON A GAMING DEVICE AND EXAMPLE PLAYER INTERFACES TO A FACILITATE SUCH for a description of the various methods via which a session may be priced.

The available sessions database may be utilized, for example, to appropriately configure a gaming device based on the values of the various parameters defining a particular session. For example, in one embodiment if a player were to insert a session ticket identifying session “S-000001” into a gaming device, this may cause the gaming device to retrieve record R400-1 from the available sessions database. Based on the information in this record, the gaming device may then proceed to set a meter of “hands remaining” to “200”, a session credit meter balance to “0”, select “paytable A” for determining payouts during the session, and to place a $0.25 wager per game play during the session.

It should be noted that, in some embodiments, the gaming device may need to communicate with another device (e.g., controller 105) to determine some or all of this information. For example, in one embodiment a session ticket may have printed thereon a unique session identifier, which is transmitted to controller 105 and in response to which controller 105 transmits a session identifier to be used by the gaming device to determine the appropriate values of parameters for the session. In other embodiments, the session identifier may be printed on the ticket and may not need to be received from the controller 105.

The available sessions database 400 may, of course, store additional or different parameters and values therefore for defining a session. For example, a number of paylines to be activated (in the case of a reeled slot machine), a number of hands to be played (in the case of a card game) or the number of balls to be played (in the case of a pachinko or roulette game) may be defined. In another example, a refund amount and a threshold of losses above which the refund amount is to be provided to the player may be defined. In yet another embodiment, one or more periods of time during which the session ticket may be redeemed may be stored (e.g., in some embodiments a session ticket may have a time of day and/or day of week redemption restriction associated with it).

Other examples of miscellaneous parameters that may define a session include various restriction on play while executing the session. For example, (i) a threshold above which winnings may be collected may be a parameter of a session (e.g., if a player concludes a session with any credit amount less than 51 coins, the player is unable to cash out any value; (ii) an upper credit balance limitation may be a parameter of a session (e.g., a credit balance a player may attain within a session is “capped” at eighty); (iii) a lower credit balance limitation may be a parameter of a session (e.g., a player's credit balance may not fall beneath zero, a player's credit balance may fall beneath zero without limitation, a player's credit balance may fall beneath zero, but only as far as −100) and/or (iv) a session may include mid-session behavioral restrictions. Examples of (iv) include, without limitation, (i) denomination adjustment restrictions (e.g., a player may or may not be allowed to change denominations mid-session, and if so, in some embodiments may only do so by forfeiting an amount of duration remaining), (ii) game adjustment restrictions (e.g., same as denomination adjustment, but restricting switching games instead of denomination); (iii) wager per game play adjustment (e.g., same as denomination adjustment, but restricting switching wager per game play instead of denomination; (iv) restrictions on pauses or “time-outs” during a session (e.g., a first session type may allow up to five time outs per session (player temporarily pauses/locks up screen), while a second session may only allow one); and (v) restrictions on aesthetic/non-game-related customizable preferences (e.g., changing of song/background music, changing of colors/reel symbols/font size, etc.).

Referring now to FIG. 5, illustrated therein is a tabular representation of an example embodiment 500 of a session groupings database 224. Embodiment 500 is referred to as session groupings database 400 herein. An session groupings database 500 may be stored in a memory of a device (e.g., memory 315 of controller 300 and/or memory 210 of gaming device 200) in tabular form, or any other appropriate database form, as is well known in the art. The data stored therein may include a number of exemplary records or entries, including records R500-1 through R500-3, each defining a group of sessions that may be made available on a gaming device. Those skilled in the art will understand that the session groupings database 500 may include any number of entries.

The session groupings database 500 also defines fields for each of the entries or records. The fields specify: (i) an available sessions group identifier 502 that uniquely identifies a group of sessions and (ii) a session identifier 504 that lists the identifiers of the sessions included in the corresponding group. It should be noted that a particular session identifier may appear in more than one session group, as evidenced, for example, in records R500-1 and R500-2 (e.g., each of the groups of these respective records includes session ID “S-000001”).

In accordance with some embodiments, as described in more detail below, a player may be allowed to redeem a session ticket for one or more of a plurality of sessions. In one embodiment, a determination of which session(s) the player may redeem a session ticket for may be based on a session group identifier associated with (e.g., printed on or associated with via a record of a database) the session ticket. The plurality of sessions for which the session ticket may be output to the player, for example, in response to the player inserting the session ticket into a TITO device of the gaming device. The player may then proceed to select the session(s) for redemption from the menu of available sessions. For example, the session ticket may include a session group identifier. Upon receiving the session group identifier, a device (e.g., the gaming device 110 or controller 105) may determine the session identifiers corresponding to the group session identifier by accessing the appropriate record of a database such as the session groupings database 500. For example, if a session group ID “ASG-013” is received, it may be determined based on record R500-2 that sessions “S-000001”, “S-000007” and “S-000009” correspond to this session group identifier. In one embodiment, a session ticket may include a unique session ticket identifier but not a session group identifier. In such an embodiment, a database may store a correspondence between the session ticket identifier and one or more session group identifiers, such that based on the session ticket identifier a session group identifier may be determined and the process above may be continued therefrom.

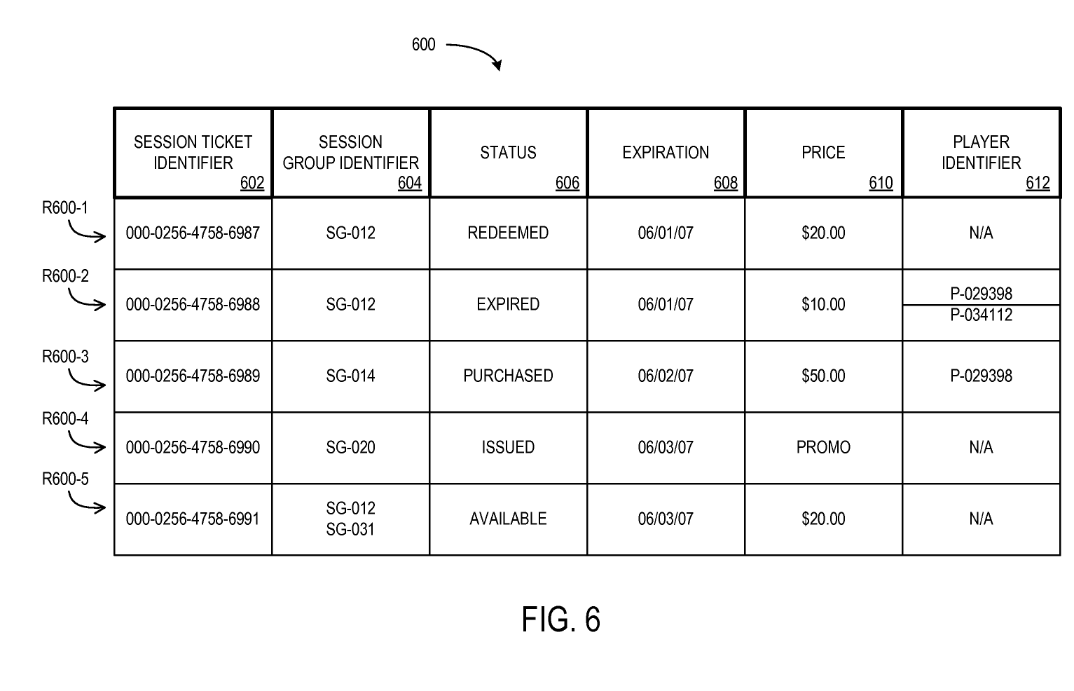

Referring now to FIG. 6, illustrated therein is a tabular representation of an example embodiment 600 of a session tickets database 325. Embodiment 600 is referred to as session tickets database 600 herein. A session tickets database 600 may be stored in a memory of a device (e.g., memory 315 of controller 300 and/or memory 210 of gaming device 200) in tabular form, or any other appropriate database form, as is well known in the art. The data stored therein may include a number of exemplary records or entries, including records R600-1 through R600-5, each defining a session ticket that has been created, issued and/or sold or otherwise provided to a player. For example, a session ticket may be created but not yet printed, sold or otherwise provided to a player yet still have a corresponding record in the session tickets database 600. Those skilled in the art will understand that the session tickets database 600 may include any number of entries.

The session tickets database 600 also defines fields for each of the entries or records. The fields specify: (i) a session ticket identifier 602 that identifies a ticket; (ii) a session group identifier 604 that identifies the session group(s) associated with the session ticket (it should be noted that in some embodiments more than one session group may be associated with a particular session ticket); (iii) a status 606 that indicates a status of the session ticket (e.g., available, issued, sold, redeemed, invalid, expired, etc.); (iv) an expiration 608 that indicates a time (e.g., time of day, week, month or year) after which the session ticket is no longer redeemable; (v) a price 610 that indicates a price (e.g., a retail price for which the ticket may be or has been sold, a price to the casino for issuing the ticket, a cash value of the ticket, etc.); and (vi) a player identifier 612 that indicates one or more player identifiers associated with the corresponding session ticket.

It should be noted that the session ticket identifier 602 may or may not be unique to a particular ticket. For example, in some embodiments a group of tickets having the same session ticket identifier may be issued. Validation of such tickets may include a determination of whether the maximum number of tickets having such an session ticket identifier have been redeemed. In other embodiments, however, each session ticket may include thereon a unique session ticket identifier. Additionally, in embodiments in which a group of tickets is created and it is desired to associate the tickets with one another, the session tickets may further include a meta-identifier that identifies the group of tickets to which each ticket in the group belongs.

It should further be noted that in some embodiments black-out dates may be associated with a session ticket (e.g., session ticket may be redeemed any Mon-Fri but not on Christmas Day even though that falls on a weekday). In such embodiments, an additional field for black out dates and/or times may be included in session tickets database 600. In some embodiments, black-out dates and/or times may be system wide (i.e., no session ticket may be redeemable during a black-out date and thus there may be no need to store such information in association with a particular session ticket, as the system will be programmed to know this information). Similarly, in some embodiments a session ticket may only be redeemable during certain times (e.g., of day, week, month or year). Accordingly, the session tickets database may store the times during which a particular ticket is redeemable.

It should further be noted that the player identifier 612 may, in some embodiments, identify a player associated with a ticket by storing one or more identifiers of accounts associated with a player (e.g., credit or other financial account). In other embodiments, the player identifier 612 may store other identifying information identifying a player (e.g., name, e-mail address, postal mailing address, telephone number, social security number, etc.).

In one embodiment, the player identifier may store an identifier of a player tracking card or player tracking account associated with a player. As would be understood by one of ordinary skill in the art, it is possible for a particular player to have more than one player identifier card for which the player is registered. In some embodiments, the player identifier 612 may store each such player identifier of each such player identifier card associated with the player (e.g., a player account database of a casino may be accessed to retrieve all such player tracking card identifiers associated with a particular player). In other embodiments, only those player identifiers of those player identifier cards provided by the player at the time the session ticket is purchased by the player or otherwise issued to the player may be stored in field 612.

Further, more than one player may be identified in the player identifier field 612. For example, one session ticket may be associated with a plurality of players. For example, the same session ticket identifier may be used on all session tickets defining a session of one million spins for any reeled slot game of a particular denomination and wager. Such session tickets may be purchased, for example, by a company for all attendees of a conference in Las Vegas as a promotion. In such an embodiment, the name of the company may appear on the session ticket and/or on the gaming device once the session is activated by insertion of the session ticket into a gaming device. In other embodiments, such a purchase of a number of session tickets, each defining a session having the same values for certain parameters defining the session, may be accomplished by providing session tickets that each have a unique identifier but that also include a further meta-identifier that identifies the session tickets as belonging to a particular group of session tickets or as otherwise sharing some kind of common characteristic.

With respect to the session group identifier 604, it should be noted that in some embodiments a session ticket may be redeemable for one session out of a group of sessions with which the session ticket is associated. Thus, for example, a session ticket may be associated with a particular session group identifier and the group identifier may in turn be associated with a plurality of sessions. In some embodiments, a player may be allowed to select a single session from the group to redeem the session ticket for (e.g., upon inserting a session ticket into a gaming device, the player may be presented with a menu of available sessions from which the player may select one session to redeem a session ticket for). This concept should be distinguished from another concept applicable to various embodiments described herein: that a single session ticket may be redeemable for more than one session. For example, in some embodiments a session ticket may be redeemable for two different sessions or for two or more instances of the same session. These two distinct concepts may both be included in some embodiments. For example, in one embodiment a player may be able to redeem a session ticket for two sessions, which two sessions the player may select from a menu of available sessions presented to the player. For example, a session ticket may be associated with a session group identifier which in turn is associated with a group of five sessions. The player may then have the option of selecting any two of the five sessions for which to redeem the ticket (or, in some embodiments, can choose to redeem the session ticket for two instances of the same session out of the group of five sessions).

The session tickets database 600 may be utilized, for example, by a device (e.g., controller 105) to validate and/or authorize redemption of a session ticket inserted into a gaming device. For example, the controller 105 may receive a session ticket identifier and, based on the identifier, access the appropriate record of the session tickets database 600. The controller 105 may then validate that the session identifier corresponds to an authentic ticket that has been issued by the casino in which the session ticket is being redeemed (or other authorized entity). The controller may further authorize the redemption of the session ticket by verifying that the status of the ticket is such that redemption is allowed (e.g., the ticket has not yet been redeemed, has not expired, the current date/time is not within a black-out date/time associated with the ticket, the ticket is being redeemed at a gaming device, game, type of gaming device and/or type of game that is authorized for the ticket, etc.).

The controller 105 or other device utilizing the information in the session tickets database 600 may further use the information in this database to transmit information to the gaming device at which the ticket is being redeemed or at which redemption of the session ticket is being attempted. For example, the controller 105 may transmit the session group identifier 604 (or an indication thereof) associated with the session ticket, to allow the gaming device to output to the player the appropriate choices in a menu of sessions for which the session ticket is redeemable (e.g., based on the session group identifier the gaming device may access the session groupings database 500 to determine the sessions associated with the ticket). In one embodiment, if the ticket is not validated or authorized, the controller 105 or other device may transmit to the gaming device an indication of the failure to validate and/or authorize and, in one embodiment, the reason(s) therefore.

In one or more embodiments, the session tickets database 600 may store additional information with respect to a session ticket. Examples of such information include: (i) a cash equivalent of the session ticket; (ii) a game, game type, gaming device, gaming device type and/or area of the casino at which the session ticket is redeemable; (iii) a time at which the session ticket was issued; (iv) a type of the session ticket (e.g., whether the ticket was a purchased ticket or one given to a player as a promotion); (v) a catalog or other document number associated with the ticket (e.g., in some embodiments session tickets may be offered, printed, or otherwise provided to players via catalogs); and/or (vi) a package identifier of a package within which the session ticket was provided. With respect to the last example, as described in more detail below, in some embodiments session tickets may be provided in packages of products (e.g., a package including a stay at a casino hotel, a meal at a casino restaurant, services at a casino spa and one or more session tickets).

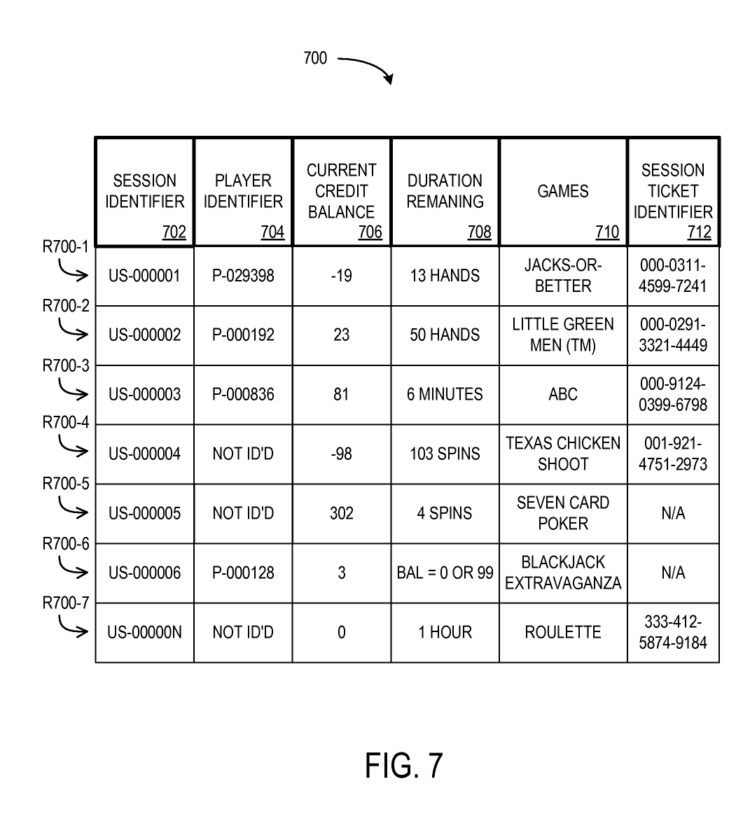

Referring now to FIG. 7, illustrated therein is a tabular representation of an example embodiment 700 of an active sessions database 330. Embodiment 700 is referred to as active sessions database 700 herein. An active sessions database 700 may be stored in a memory of a device (e.g., memory 315 of controller 300 and/or memory 210 of gaming device 200) in tabular form, or any other appropriate database form, as is well known in the art. The data stored therein may include a number of exemplary records or entries, including records R700-1 through R700-7, each defining a session that is currently being participated in by a player (this may include sessions that have been initiated but paused and expected to be resumed). Those skilled in the art will understand that the active sessions database 700 may include any number of entries.

The active sessions database 700 also defines fields for each of the entries or records. The fields specify: (i) a session identifier 702 that identifies (e.g., uniquely) a session; (ii) a player identifier 704 that identifies (e.g., uniquely) a player associated with the session (e.g., the player who is currently playing a session; the player identifier of the player tracking card inserted into a gaming device during the session); (iii) a current credit balance 706 that indicates a current balance of credits available for wagering on game plays of the session; (iv) a duration remaining 708 that indicates a duration (or expected duration) of the session remaining as of the time this information was last updated; (v) a game 710 being played during the session (e.g., Little Green Men™, Jacks-or-Better; and (vi) a session ticket identifier 712 that identifies the one or more session tickets, if any, associated with the session (e.g., the session ticket identifier that was used to initiate the session).

It should be noted that, in some embodiments, the session identifier 702 may be unique. In other embodiments, the session identifier may identify a type of session or session having certain values for certain parameters and may thus not be unique.

In some embodiments, the session identifier 702 and the session ticket identifier 710 may be the same identifier (i.e., the session ticket identifier may be used to uniquely identify the session). In other embodiments, even if a session is initiated via a session ticket identifier, a unique session identifier may be created, determined and/or assigned to the session beyond the session ticket identifier.

It should be understood that a session identifier may be created, determined and/or assigned at various points in time (e.g., at the time a session is purchased, at the time the session is initiated (if different from time of purchase), at the time a session is made available to players, etc.). A session identifier may be created, determined and/or assigned by a gaming device 110, a controller 105 or by another entity.

An active sessions database 700 may be used, for example, to track a player's progress in a session. For example, upon a player initiating a session, a record may be opened in an active sessions database by a gaming device 200 or controller 300 to track the progress of the session. Such tracked information may be useful, for example, in order to allow a player to pause and later resume a session, to determine when a session has ended or should be terminated, to determine comp points to award to a player, to determine additional sessions or session tickets to offer to a player or for which a player qualifies, etc.

In some embodiments, a database distinct from the active sessions database may be used to track paused sessions that have been started and stopped prior to an ending of a duration defined by the session (e.g., a “Paused Sessions Database”), which database may be accessed to determine how to configure a gaming device at which a player is resuming a session previously begun (e.g., to determine that the player has X out of Y game plays remaining and a credit balance of −Z credits at the time the player paused the session at this or another gaming device).

It should be noted that a player identifier 704 is not required for a player to participate in a session in some embodiments. As illustrated in records R700-4, R700-5 and R700-7, respectively, some sessions may not have a player identifier associated therewith.

It should be understood that values for various other parameters defining a session may be tracked in the active sessions database 700. For example, a paytable being used for a game during a session may be identified.

Referring now to FIGS. 8A and 8B, illustrated therein is an example of one embodiment 800 of a session ticket. Embodiment 800 is referred to as session ticket 800 herein. FIG. 8A illustrates a front view of the session ticket 800 while FIG. 8B illustrates a back view of the session ticket 800. The session ticket 800 includes various information informing a player of at least some values of at least some parameters defining a session for which the session ticket 800 is redeemable, including the following:
i. the name of a casino 802 at which the session ticket may be redeemed;
ii. the name of the game(s) 804 for which the session ticket may be redeemed;
iii. the times 806 during which the session ticket may be redeemed;
iv. the session ticket identifier 808 of the session ticket;
v. the time at which the session ticket was issued, purchased or created 810;
vi. the number of game plays 812 that defines the duration of the session (as described herein, durations of sessions may be defined in other terms as well);
vii. a description of a type of gaming device 814 at which the session ticket is redeemable;
viii. a wager amount per game play 816 that is to be applied during the session; and
ix. a bar code 818 readable by a TITO component of a gaming device.

With respect to (ix), it should be noted that the bar code may included encoded information of various types. For example, the bar code may include one or more of (i) a session ticket identifier, (ii) a session group identifier; (iii) a session identifier; (iv) a player identifier; (v) a game identifier; (vi) a game type identifier; (vii) a gaming machine identifier; (viii) a gaming machine type identifier; and (ix) a player identifier. Of course, a session ticket may include any or all of this information in human readable form as well, as is illustrated by some of the human readable information depicted on the session ticket 800.

In some embodiments, a session ticket may comprise a paper substrate (e.g. a thin paper ticket similar in size and/or appearance to a cashless gaming ticket). In other embodiments, it may comprise a thick paper ticket more similar to those used by arcades. Of course, embodiments of the present invention are not limited to paper tickets. Rather, any form of tangible media may be used as a session ticket. For example, a plastic card such as a magnetic stripe card similar in size and/or appearance to a player tracking card typically issued by casinos may comprise a session ticket. In some embodiments the session ticket, in whatever form, may also function as a player tracking card. In some embodiments, a session ticket may comprise a smart card (e.g., comprising memory instead of a magnetic stripe for encoding data).

In some embodiments, a session ticket may comprise a coin, lammer, token (e.g., for use in slot machines) and/or chip. For example, a chip similar in appearance to a betting chip used in table games may be used. In some embodiments, such a chip may comprise one or more of a magnetic stripe for encoding data, an electronic memory for storing data, an RFID transponder for emitting a signal (output of data), an RFID receiver for receiving a signal (receipt of data), and/or markings for being read by an optical scanner.

In some embodiments, a session ticket may comprise a wearable item. For example, media may be attached or integrated into clothing or jewelry (e.g., wristband/bracelet, ring, necklace, button, t-shirt).

In some embodiments, a session ticket may comprise a personal electronic devices. For example, an iPod™, PDA, cellular phone or other device comprising (i) memory and (ii) means for communicating with gaming device (e.g., infrared/wireless, etc.).

Referring now to FIG. 9, illustrated therein is an example embodiment 900 of a plastic card that may function as a session ticket, as well as an example embodiment 950 of a token or chip that may function as a session ticket. It should be noted that the embodiment 950 includes an updatable display 955 for displaying a value of a parameter of a session, although such a display is not necessary. For example, the number of hands of a game in a table game may be updated using such a chip. Further description of how a display or sound-emitting device may be included in a chip and updated to reflect a changing value may be found in commonly-owned U.S. patent application Ser. No. 09/597,801, filed on Jun. 20, 2000 and entitled GAMING TOKEN HAVING A VARIABLE VALUE. The entirety of this application is incorporated by reference herein.

Referring now to FIG. 10, illustrated therein is a flowchart of an example process 1000 that is consistent with one or more embodiments described herein. The process 1000 includes the following steps, each of which is described in detail herein: (i) issuing a session ticket, the session ticket indicating a manner in which to configure a gaming device for a session (Step 1005); (ii) receiving the session ticket (Step 1010); (iii) configuring the gaming device for session play based on the session ticket (Step 1015); and (iv) updating data associated with the session ticket (Step 1020). The process 1000 may be performed, for example, by a casino issuing and redeeming session tickets in accordance with embodiments described herein.

Of course, process 1000, as well as any other process described herein, may be performed by any device or combination of devices that is practicable and desirable (e.g., gaming device 110 and/or controller 105). Further, as also applies to all processes described herein, the steps may be performed in an order different from that illustrated and additional or different steps may be included. Similarly, some steps may be omitted or combined.

Step 1005 of issuing a session ticket may comprise, for example, providing (e.g., selling) a session ticket to a player. For example, in one embodiment a session ticket may be sold to a player in exchange for a price (e.g., a $20 bill, a $40 debit from an electronic account, an agreement to pay $20 via garnishing of future winnings of the player, a $30 charge to a credit card). It should be noted that various systems and methods for providing a benefit to a player in exchange for the player's agreement to have future winnings garnished as payment for the benefit may be found in commonly-owned U.S. patent application Ser. No. 10/420,066, filed Apr. 21, 2003 in the name of Walker et al. and entitled METHOD AND APPARATUS FOR EMPLOYING FLAT RATE PLAY and commonly-owned U.S. patent application Ser. No. 11/577,633, filed Apr. 20, 2007 in the name of Sammon et al. Each of these Applications is incorporated by reference herein.

In some embodiments, a session ticket may be provided in exchange for other consideration (in addition to or in lieu of a monetary amount). For example, a session ticket may be provided to the player in exchange for the player performing some value-added activity (or agreeing to perform such). Examples of activities in exchange for which a player may be issued a session ticket include: (i) a player answering one or more survey questions; (ii) a player purchasing a product or service other than a session ticket (e.g., a magazine subscription, a spa service, a hotel room reservation); (iii) a player signing up for a service (e.g., a credit card or cellular telephone contract); (iv) a player agreeing to perform an activity (e.g., test driving an automobile).

In some embodiments, a session ticket may qualify to receive a session ticket based on his player history, status, purchase of a good or service and/or demographics. The player may qualify to receive such a session ticket for free (e.g., as a comp or promotion) or at a discount from a regular retail price of the session ticket. For example, if a player's gambling history indicates appropriate data (e.g., that the player has generated a certain amount of theoretical win, actual win, has wagered a certain amount over a specified period of time, has played a certain amount of video poker over a specified period, etc.), the player may qualify to receive a session ticket (e.g., for free or at a discount). In another embodiment, if a player meets a certain status in a loyalty program (e.g., a “gold” tier player), the player may qualify to receive a session ticket. In yet another example, if a player meets certain demographic criteria (e.g., the player is over a certain age and/or lives a certain distance from the casino), the player may qualify to receive a session ticket. In yet another example, if a player purchases a ticket to an entertainment event, the player may qualify to receive a free session ticket redeemable for a session right after the entertainment event ends.

A session ticket may be obtained by a player via various entities and/or venues. For example, a casino owner or operator may sell or otherwise provide session tickets on its premises for sessions redeemable at the casino. For example, a kiosk located at a casino may be operable to print and/or output session tickets. In one embodiment, a kiosk may be operable to print or otherwise output a session ticket that is similar in size and/or appearance to a cashless gaming ticket and that has session information printed thereon. In another embodiment, a kiosk may be operable to output a plastic card that is similar in size and/or appearance to a player tracking card and that has session information stored thereon. In one embodiment, a player may insert a smart card into a kiosk, purchase a session by also inserting cash into the kiosk, and in response the kiosk may be operable to update the data on the smart card to reflect the information of the session purchased by the player. In one embodiment, a kiosk may be operable to update a memory of a personal electronic device (e.g., cellular phone) to reflect a purchase of a session and the one or more values of the one or more parameters defining the session.

In one or more embodiments, a session ticket may be issued via a handheld device. For example, a casino employee may receive payment from player for a session and in response command a handheld device to issue (e.g., print) a session ticket. One example of such a handheld device is the 700 Series Color Mobile™ Computer Model manufactured by Intermec Technologies™ Corporation of Everett, Wash.

In one or more embodiments, a session ticket may be issued via a peripheral device in communication with a personal computer (PC). For example, a casino employee at a casino cage, hotel front desk or booth may (e.g., after receiving payment from a player) use a program of a PC to indicate that a session ticket should be printed, and a printer in communication with the PC may thus print the ticket.

As described herein, in one or more embodiments, a casino employee may provide a session ticket to a player as a promotion, gift or comp. For example, the casino employee may hand to a session ticket worth “one free promotional session.”

In another example, a session ticket may be mailed to a player. Alternatively, a session ticket may be provided to a player upon checking in to a hotel affiliated with a casino (e.g., as part of the player's welcome package). In yet another example, a session ticket may be provided to a player when the player makes a purchase at a retailer affiliated with a casino (e.g., a POS terminal may print out a session ticket and a clerk may give the session ticket to the player with his receipt).

In one embodiment, a session ticket may be issued to a player via an automated or manual dispenser. Such a dispenser may be operable to, for example, dispense session tickets off of a roll, or from a cartridge. Such a dispenser may be located, for example, in a game area of a casino (e.g., affixed to the side of a game machine) or near a POS terminal. In one embodiment, a gaming device (e.g., gaming device 200) may be operable to print a session ticket (e.g., a TITO module of the gaming device or other printing device may be operable to print a session ticket).

It should be noted that in some embodiments a session ticket issued to a player in this manner may not be “activated” in the sense that it may be immediately be redeemable unless and until a player performs some other qualifying activity. For example, a player may be required to sign up for a player tracking card or check into a hotel associated with a casino that issued the session ticket.

The session ticket issued in Step 1005 indicates a manner in which a gaming device is to be configured for a session associated with the session. As described above (e.g., at least with reference to FIG. 8), there are various manners in which a session ticket may indicate a manner in which a gaming device is to be configured for session play. For example, the session ticket may include thereon human-readable medium. For example, text printed on the session ticket may indicate a manner in which a gaming device will be configured for a session (e.g., “200 Poker Hands”). In another example, graphics may be used to indicate a manner of in which a gaming device will be configured for a session (e.g., a session ticket depicts 8 “session tokens,” each token associated with one available session the player may play). In yet another example, an LED meter on token or smart card may indicate a number of available game plays for a session. In still another example, session tickets (e.g., session tickets comprising paper substrates) may be “color-coded” by type of session (video poker tickets are red, slot tickets are yellow, etc.).

In some embodiments, data may be represented or encoded on a session ticket in machine-readable form. For example, as depicted in FIG. 8, a session ticket may include a barcode encoding data or, as depicted in FIG. 9, a magnetic stripe of a plastic card comprising a session ticket may encode data. In another example, a memory of a smart card or chip may store data or a memory of a personal electronic device comprising a session ticket may store data.

It should be understood that in some embodiments data may be depicted on a session ticket in human-readable form as well as included in machine-readable form. In some embodiments, the data in machine-readable form may be all or a subset of the data depicted on the session ticket in human readable form. In another embodiment, the data in machine-readable form may include all of the data included in human-readable form. In yet another embodiment, the data in machine-readable form may include data different from the data in human-readable form (as a supplement to or in place of the human-readable data).

Referring now to Step 1010, receiving a session ticket may comprise, for example, receiving the session ticket at a gaming device (e.g., a gaming device 200). For example, the session ticket may be received at a mechanical or video reel slot machine, a video poker machine, a handheld gaming device (e.g., one that comprises a session ticket scanner), or a device operable to facilitate a table game.

If the session ticket comprises a plastic card, receiving the session ticket may comprise determining that the card has been inserted into a reader device (e.g., such as the iView™ device manufactured by Bally Technologies™ of Las Vegas, Nev. or the ACF30 Serial Floppy Bay Smart Card Reader offered by Didya.com of Monroe, N.C.). If the session ticket comprises a paper substrate, receiving the session ticket may comprise determining that the session ticket has been inserted into TITO device or bill validator of a gaming device. If the session ticket comprises a token, coin or chip, receiving the session ticket may comprise determining that the session ticket has been inserted into a token, chip or coin acceptor of the gaming device. If the session ticket comprises information stored electronically on a device, receiving the session ticket may comprise receiving a wireless signal or transmission from the device. Receiving a wireless signal or transmission may comprise, for example, receiving the signal or transmission in upon a player request (e.g., player may hold an infrared smart card or token up to a reader of a gaming device). In another example, a gaming device may be programmed to automatically recognize and read information from a session ticket via RFID (“I see that you have a magic token in your pocket”). These latter wireless transmission embodiments are particularly applicable for wearable media (e.g., bracelet, ring), but also possible for smart cards, tokens, personal electronic devices (e.g., Bluetooth from cellular phone), etc.

Referring now to Step 1015, once a session ticket is received at a gaming device, the gaming device is configured in the manner indicated by the session ticket. For example, in one embodiment, Step 1015 may comprise outputting a menu of available sessions to a player via a display of the gaming device. The available sessions included on the menu may be based on a session group identifier associated with the ticket. For example, the session group identifier may be read from the session ticket directly and a session groupings database (e.g., session groupings database 224) may be accessed to determine the sessions associated with the session group identifier. As described, in some embodiments such a session groupings database may be stored in at a central server (e.g., controller 105) while in others it may be stored locally on a gaming device. In another example, a session ticket identifier may be read from the session ticket and transmitted to another device (e.g., controller 105). The other device may then determine the session group identifier associated with the session ticket identifier and transmit it back to the gaming device. This latter arrangement allows for changes to the session group associated with a ticket after the session ticket has been issued even in circumstances under which such changes cannot easily be effected at a gaming device (e.g., if downloading such changes to a gaming device is not possible or is not preferred and changing a chip storing such information in a gaming device is too resource intensive). Once a session group identifier is determined and the sessions associated therewith are identified, information about the sessions may be output via a menu (e.g., the information about each such session may be retrieved from a database, such as the available sessions database 222). Once the menu of available sessions is output, a selection may be received from a player of the particular session the player desires to redeem the session ticket for. In response to such a selection, the gaming device may be configured to the values of the parameters of the selected session (e.g., starting session credit balance may be set to the appropriate number of credits and the session termination meter may be set to the appropriate value, such as 200 hands for a 200 hand video poker session).

Of course, in some embodiments, a session ticket may be associated with a single session (whether via a session group that includes only a single session or via being associated with a session identifier directly). In such embodiments, Step 1015 may comprise configuring the gaming device to the values of the parameters of the particular session, rather than first outputting a menu of available sessions.

In one embodiment, Step 1015 may comprise reading or otherwise determining data printed, encoded or stored on a session ticket and configuring a gaming device based on such date (in some embodiments, this may involve retrieving or otherwise determining additional data). There are various manners in which the data of a session ticket may be accessed, depending on the type of session ticket. For example, if the session ticket is a plastic card with a magnetic stripe, accessing the data may comprise utilizing a reader device to determine the encoded data of the magnetic stripe. If the session ticket comprises a plastic smart card, accessing the data may comprise utilizing a reader device to access volatile memory of the smart card such that data stored thereon may be determined. If the session ticket comprises a paper substrate, accessing the data may comprise reading a bar code of the session ticket by utilizing a TITO device to scan the bar code and determine the data of the bar code. If the session ticket comprises an RFID-enabled token, chip, coin or other marker, accessing the data may comprise receiving data from an RFID transponder embedded in the token, chip, coin or marker by utilizing an RFID receiver of the gaming device. If the session ticket comprises a personal electronic device operable to communicate wirelessly, accessing the data may comprise receiving data via a wireless communication using a wireless protocol (e.g., Bluetooth™).

The data that may be printed, encoded, stored or otherwise indicated by a session ticket that is indicative of a manner in which to configure a gaming device for one or more sessions may, in some embodiments, be a pointer to a record of a database that stores detailed data of how a gaming device should be configured for a session. For example, in one embodiment a session ticket may indicate a session identifier and/or a session ticket identifier, which may be used to determine data defining a session by accessing one or more records of one or more databases based on one or both such identifiers. In some embodiments, a dealer at table game may review a session ticket and configure a table for session play accordingly.

A session identifier and/or a session ticket identifier may comprise a numeric, alphanumeric and/or other code identifying a unique gaming session or identifying a type of gaming session (e.g., in some embodiments the session ticket may be a unique identifier but the same session identifier identifying a session having particular values for particular parameters may be included on multiple session tickets). For example, as a session ticket may have printed thereon a session identifier of “session # S-0001111”, a bar code printed on the session ticket may encode the session identifier barcode encodes “S-000111” (e.g., if the session ticket comprises a paper substrate), a magnetic stripe included on the session ticket may encode the session identifier “S-000111” (e.g., if the session ticket comprises a plastic card such as a player tracking card) and/or the session ticket may comprise a memory which stores the session identifier “S-000111” (e.g., if the session ticket comprises a smart card).

As described herein, in one or more embodiments, a session ticket may be redeemable for more than one session. Thus, in such embodiments the session ticket may indicate (e.g., via a session identifier or session ticket identifier) a number of sessions or types of sessions for which the session ticket is redeemable (in one or more of human readable and machine readable forms). For example, a session ticket may indicate to a player that the player is entitled to execute “2” of a particular type of session (e.g., a balance of “2” is available in association with session type “S-000111,” meaning the player can play through two separate sessions, each session characterized by the same values of the same parameters). In such embodiments, a record of a database may be updated as the player executes each allowable session, decrementing the number of such available sessions. Further, in some embodiments if a player executes a session but one or more sessions still remain as available to the player, a session ticket may be updated (e.g., a memory of a smart card or data encoded on a magnetic stripe may be updated) or a new session ticket may be output (e.g., printed, in embodiments in which the session ticket comprises a paper substrate) to reflect the updated number of available sessions associated with the session ticket. For example, in a table game embodiment, a hole may be punched in a ticket by a dealer, etc.).

As described, in some embodiments a gaming device processor may determine respective values associated with various parameters based on a session identifier and/or a session ticket identifier associated with a ticket (as described, the session identifier may be associated directly with the session ticket or indirectly via a session group identifier and player selection of a particular session from the group of available sessions). Thus, parameters of a gaming device defining a session may be set/programmed to the respective values defining a session such that the gaming device is configured for a particular session. In one embodiment, as described with respect to FIG. 4, a relational database (e.g., available sessions database 400) may be stored by a gaming device (e.g., gaming device 200) and/or server (e.g., controller 300) and may indicate values in association with various parameters, each for different session identifiers. Examples of some types of parameters that may be used to define a session are described above with respect to FIG. 4.

As also noted with respect to FIG. 4, certain sessions may only be redeemable on a particular game (e.g., “Little Green Men™”), game type (e.g., any video poker game), gaming device (e.g., gaming device “GD-001024”), gaming device type (e.g., any 5 reeled penny slot), manufacturer (e.g., a gaming device manufactured by “Company XYZ”), and/or game within a particular casino location. Thus, in some embodiments, process 1000 (or another process) may include steps for validating and authorizing redemption of a session ticket by determining whether the gaming device at which the redemption of the session ticket is being attempted is a gaming device that fits within the session for which the session ticket is redeemable (e.g., the gaming device identifier matches the gaming device identifier of the session ticket, the gaming device supports a game or game type associated with the session ticket, the gaming device is located in an area of the casino associated with the session ticket, etc.). Process 1100, described below with respect to FIG. 11, describes in more detail the types of considerations which may be involved in validating and authorizing a session ticket. It should be understood that, in some embodiments, Step 1015 of configuring a gaming device in a manner consistent with the session associated with the session ticket may only be performed after a successful validation and authorization of the session ticket is performed. In other words, process 1100 or a similar process may be performed once a session ticket is inserted into a gaming device and Step 1015 (as well as Step 1020) may only be performed if the validation and authorization of the session ticket is successful.

In some embodiments, Step 1015 may comprise determining a price paid for a session. For example, in some embodiments a coin-in and/or coin-out meter of a gaming device may be adjusted based on a price paid for a session (e.g., a price paid for a session may be amortized over the number of game plays defined by the session to determine an amount by which to increase a coin-in meter upon initiation of each game play of a session). The interested reader is referred to commonly-owned U.S. application Ser. No. 11/765,149, filed on Jun. 19, 2007 in the name of Nee et al. and entitled APPARATUS, SYSTEMS AND METHODS FOR GAMING DEVICE FEATURING NEGATIVE CREDIT BALANCE for a detailed discussion of how a price paid for a session may effect an adjustment of a coin-in meter and/or coin-out meter of a gaming device during execution of a session. Accordingly, in some embodiments a price paid for a session may be determined (e.g., received from controller 105, read from a session ticket, determined from data stored in a local memory of a gaming device based on data read from a session ticket, etc.) and used to configure the gaming device in one or more manners. For example, an amortized amount by which to increase a coin-in meter of the gaming device during the session may be determined and stored in a memory (e.g., in cache, FLASH memory or RAM of the gaming device or in another temporary fashion).

Again, as noted herein, while in some embodiments information defining a session (e.g., respective values of one or more parameters defining a session) may be stored in a database that is accessed based on an identifier indicated by a session ticket, in other embodiments at least some of such data may be included on, encoded in or stored in the session ticket itself (in addition to or in lieu of being stored in a database). In the latter embodiments, the data may be encrypted or otherwise secured to prevent tampering by a player or other parties. In such embodiments, a gaming device 110 and/or a controller 105 may be operable to decrypt such data (e.g., using a secret key stored be either or both devices).

It should be noted that, in some embodiments, configuring a gaming device for a session may constitute an initiation of the session by a player and thus a session ticket provided by a player to initiate the configuration and thus the session ticket may be non-refundable and confiscated at the time of initiation. In another embodiment, a session ticket is not considered redeemed until the first game play of the session is initiated and thus the session ticket may be returned to the player (e.g., upon the player's request if the player were to change his mind after the configuration of the gaming device but prior to initiating a game play of the session).

Referring now to Step 1020, data associated with a session ticket is updated based on one or more of (i) redemption of the session ticket, (ii) progress of the session associated with the session ticket; and (iii) adjustments made during the session associated with the session ticket. Such data may be adjusted by (i) updating a local memory of a gaming device; (ii) updating data stored or encoded on a session ticket (although in some embodiments any updates to a session ticket may not be performed until there is a request from the player to end the session, remove the session ticket (in the case of a smart card or plastic card) or have an updated session ticket printed (in the case of a paper substrate); and (iii) updating data stored in a record of a database stored in a gaming device 110 and/or a controller 105 (e.g., the active sessions database 330). It should be noted that, in some embodiments, data may not be updated until some time after a session concludes (e.g., session tickets are collected in a drop box at a table game, and accounted for, electronically or otherwise, at the end of the day).

Again, it should be noted that in some embodiments a session ticket may be considered redeemed at various times. For example, a session ticket may be considered redeemed at the time a request for redemption of it is authorized. In another example, a session ticket may not be considered redeemed until a gaming device is configured for a session associated with the session ticket. In yet another example, a session ticket may not be considered redeemed until a player initiates a first game play of a session associated with the session ticket. In yet another example, a session ticket may not be considered redeemed until a player initiates and/or completes a final game play of a session associated with the session ticket.

The data associated with a session ticket that is updated may simply be data relating to the progress of the session. For example, the duration remaining may be updated based on passage of time, execution of game plays or occurrence of another event defining the duration, as appropriate based on the manner in which the duration of the session is being tracked. In other embodiments in which a value of a parameter defining a session may be adjusted during the session (e.g., the wager per game play may be adjusted in some sessions, the game played may be adjusted in others), updating the data associated with the session ticket may comprise updating the value of the relevant parameter.

In some embodiments, Step 1020 may include a deactivation of the session ticket upon any of the following events: (i) authorization of the session ticket; (ii) initiation of the session or (iii) completion of the session. For example, Step 1020 may comprise setting the status (e.g., in a record of a database) of a session ticket to “Redeemed” or a similar status indicating that the session ticket cannot be authorized for use in the future (e.g., in the status field 715 of the session tickets database 700). In another embodiment, deactivation of the session ticket may comprise storing an indication of the redemption of the session in a memory of a smart card comprising the session ticket. In another embodiment, deactivation of the session ticket may comprise printing or otherwise marking an indication of “redeemed” across the paper substrate comprising the ticket (in other embodiments, a paper session ticket may simply be confiscated by a gaming device upon redemption of the session and a new session ticket may be printed if there is a session or part of a session remaining as available for redemption).

An example of a use of the process 1000 utilizing the databases and data of FIGS. 4-7 will now be briefly described, to illustrate examples of what the steps of process 1000 may comprise. Assume that a player picking up tickets for an entertainment event is provided with a session ticket for use after the entertainment event. In other words, a session ticket is issued to the player (Step 1005). Further assume that the session ticket issued to the player is session ticket “000-0256-4758-6987” of record R600-1 of table 600 (FIG. 6). Further assume that the entertainment event ends at 9:45 pm on Jun. 1, 2007 and the session ticket is redeemable only during 9:45 pm-10:45 pm on Jun. 1, 2007 (although this information is not shown in record R600-1). It should be noted that although a price of “$20.00” is associated with this session ticket in table 600, in this example the session ticket may be provided to the player at no fee (e.g., as a promotion for enticing the player to gamble on the casino floor after leaving a show at the casino). In some embodiments, session tickets provided to players at no charge (e.g., as a comp or promotion) may only be issued for sessions that do not have a publicly available price, to minimize the chances that a player would easily be able to determine the value of the session ticket being provided to him at no charge.

In Step 1010, the session ticket is received at a gaming device 200 and the gaming device 200 determines the session ticket identifier “000-0256-4758-6987” from the session ticket. The gaming device 200 transmits this session ticket identifier to controller 300. The controller 300 accesses the session tickets database 600 based on this identifier, retrieves record R600-1 and determines that the session ticket is associated with session group “SG-012”. The controller 300 further validates the session ticket as being one that was legitimately issued by an authorized entity and authorizes the redemption of it by, for example, verifying that the current date and time is within the acceptable date and time for redemption associated with the ticket. If the session ticket were associated with a particular gaming device, game or other information limiting its redemption, the controller 300 would further verify that the session ticket is redeemable on the gaming device 200 that requested the redemption. A more detailed discussion of what validating and authorizing a session ticket may entail is provided below with respect to the description of process 1100 (FIG. 11). Assuming the session ticket is validated and authorized, the controller 300 transmits an indication of the validation and authorization to the gaming device 200 along with the session group identifier “SG-012”. Of course, a live dealer at a table game could inspect a session ticket to determine its validity (e.g., the ticket is for the right game, an appropriate time/date, does not appear to be counterfeit, etc.).

In Step 1015, the gaming device 200 retrieves the appropriate record of session groupings database 224, embodied as embodiment 500, and determines, based on record R500-1, that session group “SG-012” is associated with session “S-000001” and session “S-000002”. The gaming device 200 accesses the available sessions database 222, embodied as table 400, and determines information for each of these sessions. The gaming device 200 then outputs a menu of options to the player, the menu describing option one as the session identified as session “S-000001” and the other option as the session identified as the session “S-000002”. It should be understood that displaying this menu of options may include displaying the information defining the sessions in a player-friendly fashion. For example, graphics representing the games or game types for which each session is redeemable may be displayed in conjunction with the duration, active pay combos, denomination, wager per game play and starting credit balance information for each session. A player selection of one of the session is received and the gaming device 200 is configured in accordance with the values of the parameters defining the selected session. For example, assuming session “S-000002” is selected, configuring the gaming device may comprise (based on record R400-2 of table 400) setting a “number of hands remaining” meter to 100 hands, setting the starting credit meter balance to zero credits, setting the wager per game play to be 1 coin (the coin having a value of $1.00) and selecting “paytable B” as the paytable for determining payouts during the session.

Finally, Step 1020 in the present example may comprise updating record R600-1 of table 600 to reflect the redemption of session ticket 000-0256-4758-6987. In accordance with one embodiment, this comprises setting the status of this session ticket to “redeemed” and retaining the session ticket inserted into the gaming device 200. In this manner, a player cannot reuse the session ticket and an attempted subsequent redemption of the session ticket (e.g., if the player were to have made an unauthorized copy of the session ticket prior to redeeming it and then attempted to redeem it again) would be denied. Of course, this example presupposes that the session ticket 000-0256-4758-6987 is only redeemable once. If it were redeemable more than once (e.g., for two or more sessions), step 1020 may comprise issuing a new ticket (e.g., printing a new session ticket by a TITO device of gaming device 200), the new session ticket reflecting the updated number of sessions (based on the current redemption of the current session) that remain associated with the session ticket. The new session ticket may, in some embodiments, include a new unique session ticket identifier.

Referring now to FIG. 11, illustrated therein is a process 1100 of validating and authorizing a session ticket for which a redemption request is received at a gaming device. In accordance with some embodiments, validation of the session ticket comprises a verification that the session ticket is one legitimately issued by an authorized party (e.g., the casino at which the gaming device is located). Authorization of the session ticket, on the other hand, may comprise determining that the session ticket is currently redeemable at the gaming device at which the request for redemption of it is being made.

Accordingly, process 1100 begins when a session ticket identifier is received (step 1105). Step 1105 may comprise, for example, a gaming device 200 reading the session ticket identifier from a session ticket inserted into a TITO device of the gaming device. In some embodiments, Step 1105 may comprise controller 300 receiving the session ticket identifier from a gaming device 200 into which the session ticket had been inserted and which had read the session ticket identifier from the session ticket.

In Step 1110, it is determined whether the session ticket is valid. This may comprise determining whether the session ticket identifier is one that was legitimately created by an authorized entity. For example, the form and/or format of the session ticket identifier may be analyzed to determine whether it is correct and/or conforms to a standard (e.g., does it include the correct number of digits?). In another example, a database of created session tickets may be accessed to determine whether the session ticket identifier matches a session ticket identifier stored in the database. In one embodiment, such a database may include all session ticket identifiers ever issued by an authorized entity and thus, if the received session ticket identifier does not match one stored in the database, it may be concluded that the session ticket identifier is not valid.

In one embodiment, Step 1110 is performed by a controller (e.g., controller 300). For example, a gaming device 200 may transmit the session ticket identifier to controller 300 for validation. In another example, a gaming device 200 may be operable to validate a session ticket identifier locally (e.g., the gaming device may be operable to check the form and/or format of the session ticket to determine whether it conforms to a standard and/or be operable to access a database of legitimately created session ticket identifiers to determine a match).

If it is determined, in Step 1110, that the session ticket identifier is not valid, an indication of the inability to validate the corresponding session ticket is output (Step 1115). For example, a controller 300 performing the validation of the session ticket may transmit to the gaming device 200 into which the session ticket was inserted an indication of the inability to validate the session ticket (e.g., via a code or other message). In one embodiment, such an indication of the inability to validate the session ticket may include a reason or indication (e.g., code) of the reason therefore. In such embodiments, the gaming device 200 that receives the indication of the inability to validate the session ticket may output a message to a player (e.g., via a display device) of the inability to validate the session ticket (in some embodiments, the message may include an explanation of the reason why the session ticket cannot be validated). In some embodiments, the gaming device may further be operable to confiscate the session ticket that could not be validated. In other embodiments, the session ticket may be returned to the player.

If the validation of the session ticket is successful in Step 1110, process 1100 continues to Step 1120, in which Step it is verified that the session ticket has not already been redeemed. For example, a database (e.g., session tickets database 600) may be accessed to determine whether a status corresponding to the session ticket identifier received in Step 1105 is currently set to “Redeemed.” If it is, it may be determined that the session ticket has already been redeemed and thus cannot be redeemed again. This is presupposing that the session ticket is only redeemable once. Otherwise, it may be determined whether the maximum number of redemptions for which the session ticket is authorized has been exhausted. In some embodiments, a previous redemption (or lack thereof) of a session ticket may be stored in a local memory of the session ticket (e.g., in embodiments in which the session ticket comprises a smart card or magnetic stripe card). In such embodiments, Step 1120 may comprise accessing the local memory or querying the local memory to determine whether the session ticket has already been redeemed.

If it is determined, in Step 1120, that the session ticket corresponding to the session ticket identifier received in Step 1105 has already been redeemed, process 1100 continues to Step 1125, in which Step an indication of an inability to authorize redemption of the session ticket is output. Otherwise, the process 1100 continues to Step 1130.

For example, a controller 300 performing the authorization of the session ticket may transmit to the gaming device 200 into which the session ticket was inserted an indication of the inability to authorize the session ticket (e.g., via a code or other message). In one embodiment, such an indication of the inability to authorize the session ticket may include a reason or indication (e.g., code) of the reason therefore. In such embodiments, the gaming device 200 that receives the indication of the inability to authorize the redemption of the session ticket may output a message to a player (e.g., via a display device) of the inability to authorize the redemption of the session ticket. In some embodiments, the message may include an explanation of the reason why the session ticket cannot be redeemed (e.g., an indication that the session ticket has already been redeemed). In some embodiments, the gaming device may further be operable to confiscate the session ticket that could not be authorized. In other embodiments, the session ticket may be returned to the player.

If the process continues to Step 1130, it is determined whether the current time is within acceptable redemption time(s) associated with the session ticket identifier. For example, as described herein, a particular session ticket may only be redeemable during a certain time of day (e.g., between 3 pm and 6 pm) during a certain day of the week (e.g. Monday through Thursday) or during a certain date range (e.g., Jun. 1, 2007 through Jun. 30, 2007).

In one embodiment, Step 1130 may comprise accessing a record of a database based on the session ticket identifier received in Step 1105 and comparing the current time (e.g., as tracked by a clock of a processor performing the Step) to the authorized redemption time(s) associated with the session ticket. Similarly, a session ticket may have one or more “black-out dates” associated therewith during which dates the session ticket may not be redeemed irrespective of the time(s) otherwise indicated on the session ticket as authorized redemption times. Accordingly, in such embodiments Step 1130 may comprise verifying that the current date is not within a blackout date associated with the session ticket. In some embodiments, an expiration date may be associated with a session ticket, in which embodiments Step 1130 may comprise verifying that the current date is not beyond the expiration date. Of course, in some embodiments a session ticket may always be redeemable and not be restricted as to days of the week, times of day or blackout date (but may, in some embodiments, still include an expiration date).

If it is determined that the current time is within an acceptable redemption time(s) associated with the session ticket, the process continues to Step 1135. Otherwise, the process may return to Step 1125. In some embodiments, even if the current time is not within the acceptable redemption time(s), the process may still continue to Step 1135. For example, in some embodiments a message may be output to a player associated with the session ticket upon a failure to authorize redemption of the session ticket, the message indicating all reasons why the redemption cannot be authorized. In such embodiments, it may be preferred to determine all reasons that may prevent authorization of the redemption of the session ticket, to provide a fully informative message to the player of all reasons why the session ticket cannot be redeemed as attempted.

In Step 1135 it is determined whether the session ticket is redeemable on the current gaming device (i.e., on the gaming device at which redemption is currently being attempted). As explained, in some embodiments a session ticket may have one or more restrictions associated therewith, limiting, for example, the type of gaming device, type of game, particular gaming device, particular game, location of a casino, at which session ticket may be redeemed. As described herein, many other various restrictions may be imposed on a redemption of a session ticket

In some embodiments in which a server (e.g., controller 300) is performing Step 1135, the server may store a database of gaming device data. Such a database may store, for example, a record for each gaming device located in a particular casino. Each record may store, for example, data associated with each such gaming device. Examples of such data which may be relevant to embodiments described herein include, without limitation, as a unique gaming device identifier, an indication of the type of gaming device, an indication of the manufacturer of the gaming device, an indication of the games playable on the gaming device or features available on the gaming device (either of which may be updated from time to time in a downloadable environment), a denomination of the gaming device, a current status of the gaming device, a location of the gaming device, and either current or past utilization data of the gaming device. Thus, in some embodiments Step 1135 may comprise determining a gaming device identifier of the gaming device at which redemption of the session ticket identified in Step 1105 is being attempted, accessing a gaming device database to determine relevant data associated with the gaming device, and comparing the relevant data to the gaming device-related restrictions associated with the session ticket. In another embodiment, rather than determining relevant data about a gaming device from a database, the gaming device may be queried to determine whether it matches the data associated with the session ticket.

In some embodiments in which the Step 1135 is performed by a gaming device, the gaming device may store in a local memory data which may be used to determine whether the gaming device matches the gaming-device restrictions associated with the session ticket. For example, the gaming device may be operable to determine which games it can currently support and whether one of those games is a game for which the session ticket is redeemable.

If it is determined in Step 1135 that the session ticket is redeemable on the current gaming device, the process 1100 continues to Step 1140, in which Step the redemption of the session ticket is authorized. Otherwise, the process continues to Step 1125.

Authorization of the redemption of the session ticket may comprise, for example, transmitting an indication of the authorization to a gaming device (in embodiments in which Step 1140 is performed by a server or other device other than the gaming device).

The gaming device may then, in response to receiving the authorization, configure itself appropriately (e.g., as described with reference to Step 1015 (FIG. 10). If Step 1140 is performed by the gaming device, then the gaming device upon determining that the redemption may be authorized may automatically configure itself as described with reference to Step 1015.

In some embodiments, a determination that redemption of a session ticket may not be authorized may cause one messages to be displayed to a player in addition to an outputting of an indication that the session ticket cannot be redeemed as requested. For example, an offer to sell to the player a session or session ticket that may currently be redeemed at the current gaming device may be output. In another example, directions (e.g., “To find a ‘Crazy Crustacean Slots’ machine, visit Slot Room A to your left”) and/or a map to a gaming device at which the session ticket may currently be redeemed may be output (e.g., via a display and/or in printed form). In one embodiment, such a map may be output with the one or more appropriate gaming devices at which the session ticket may be redeemed highlighted, marked or otherwise emphasized on the map. In one or more embodiments, the directions may be directions from a location at which the player associated with the session ticket is currently located. In another embodiment, the directions may be directions from a landmark location of the casino (e.g., the lobby, the fountain in the atrium, the elevator entrance, the center escalator, the statue of the eagle on the first floor, etc.) which a player should be able to easily find (e.g., based on its famous or easily recognizable nature, central location, ability to easily obtain directions to from other players or casino employees, etc.). In one or more embodiments, the directions and/or map may be wirelessly transmitted to a handheld device associated with the player.

Of course, it should be understood that the queries for determining whether redemption of a session ticket may be performed may be performed in a different order than that described. Also, additional queries may be performed, depending on the restrictions that may be associated with a session ticket. For example, as described herein, in some embodiments a session ticket may be associated with one or more particular players or one or more particular player identifiers. In such embodiments, process 1100 may include a determination of whether a player identifier inserted into a gaming device or otherwise indicated to the gaming device along with the session ticket identifier matches a player identifier associated with the session ticket. In another example, a query for authorizing redemption of a session ticket may comprise determining whether the current gaming device supports the type of session (e.g., as defined in terms of duration) for which the session ticket is redeemable (e.g., “Sorry, this machine only supports by-the-hour sessions, not hand-by-hand sessions”). In yet another example, authorization of redemption of a session ticket may be denied based on an invalid credit balance of the gaming device at which the redemption is requested (e.g., player may need to have at least N credits on the game machine before initiating the session). In yet another embodiment, authorization of redemption of a session ticket may be denied based on an invalid property of a casino at which the redemption is requested (e.g., certain session tickets may only be redeemable at one or more properties/locations (e.g., resorts owned by a particular corporation). Other examples of restrictions that may prevent redemption of a session ticket include a determination that a player has failed to perform or failed to provide proof of performing an activity that is a prerequisite for redemption of a session ticket (e.g., in some embodiments a player must also insert a voucher indicating he has eaten at a casino restaurant or a database must indicate that the player is also a hotel guest).

Referring now to FIG. 12, illustrated therein is an example of an interface of a software module usable by casino personnel for managing promotions of a casino via session tickets. As described herein, in one or more embodiments a casino may facilitate promotions via session tickets. For example, a casino may utilize session tickets to drive persons leaving an entertainment event at a casino property onto the gambling floor of the casino by providing to each person leaving the entertainment event a session ticket redeemable during a period of time that begins right after the entertainment event ends.

In another example, a casino may utilize session tickets to encourage players to try new games, new gaming machines or to visit areas of the casino that are under-utilized. Of course, the software module and interface described with reference to FIG. 12 may be used by casino personnel to print session tickets for sale as well as those provided as promotions or comps. Also, although the interface of FIG. 12 is described as particularly pertaining to issuing session tickets comprising paper substrates, it should be understood that a similar interface may be used to issue session tickets comprising another form (e.g., plastic cards).

The interface 1200 includes two example menus that may be presented to a casino employee utilizing the software to create a batch of session tickets for a particular promotion. The first menu 1205 may be utilized by the casino employee values for various parameters defining the session to be identified by a group of session tickets. Although each session ticket of such a group of session tickets may, in some embodiments, include a unique identifier, the session tickets may share common values for various parameters defining the session corresponding to the group of session tickets. For example, as illustrated a casino employee may select to have 100 session tickets created, each session ticket being redeemable fifty game plays of a particular game type, a particular game and/or a particular gaming device. Of course, other parameters may also be included on such a menu but have been omitted for purposes of brevity (e.g., a wager amount per game play and denomination may also be selected). The casino employee may also select the acceptable times of redemption for this group of session tickets.

Of course, in some embodiments a casino employee may choose not to restrict a session ticket much at all and make the session tickets of a group redeemable for any type of gaming device, any type of game, etc., so long as a gaming device is operable to support session play. For example, a casino employee interested in having persons leaving an entertainment event go right to a casino gambling area may simply select a group of session tickets with a particular redemption time (e.g., a time right after the entertainment event ends) without putting too many, if any, other restrictions on the session ticket.

In some embodiments, a casino employee may select a graphic (e.g., a graphic depicting a game or type of game) or message (e.g., promotional message or advertisement) on each ticket of the group of tickets. In other embodiments, graphics and/or text may be selected automatically for printing on a session ticket based on the values of respective parameters selected by the casino employee (e.g., if the casino employee selects game ABC as the game for which the session tickets are redeemable, a logo and/or name of the game may be automatically selected for inclusion on the session ticket).

In some embodiments, a casino employee may choose to create several groups of session tickets in a single batch, each group of session tickets sharing particular values for particular characteristics. For example, a casino employee desiring to create 200 session tickets to provide to player expected to leave an entertainment event at 2:30 pm may desire to have a first number of the session tickets be redeemable for a first type of game and a second number redeemable for a second type of game (e.g., because the casino only has the first number of gaming devices on which the first type of game is available). Accordingly, the casino employee may utilize the menu 1205 to create a batch of session tickets which includes (i) a first number of session tickets comprising a first group, the first group being for session tickets redeemable between 2:30 pm and 3:00 pm for the first game; and (ii) a second number of session tickets comprising a second group, the second group of session tickets being also being redeemable between 2:30 pm and 3:00 pm but for the second game. It should be noted that, in some embodiments, a batch and/or group identifier identifying the batch and/or group of session tickets may be included in each session ticket printed for the group and/or session. In some embodiments, a casino employee may be allowed to select a name for the batch of session tickets (e.g., to associate it with a particular promotion in furtherance of which the batch of session tickets is being created). In one embodiment, an operator may select an option to collate tickets when printed, such that booklets or other groupings of different tickets may be readily distributed.

Once a casino employee defines a batch of session tickets via menu 1205, the casino employee may be presented with a menu such as menu 1210 for providing instructions for printing the batch of session tickets. For example, the casino employee may be allowed to select a particular printer and/or time of printing the session tickets. The player may be allowed to select the number of session tickets. If more than one group of session tickets was created via menu 1205, the casino employee may be allowed to specify the number of session tickets to print for each group. The casino employee may also be allowed to select a color or other printing-related characteristic of the session tickets. For example, as described herein, session tickets redeemable for a first session r type of session may be of a first color while session tickets redeemable for a second session may be of a second color. In some such embodiments, the color for a group of session tickets may be automatically selected based on rules and a respective value selected for one or more parameters defining a session of the session tickets.

Of course it should be understood that a creation of a group of session tickets for a particular promotion need not be a manual process or entirely a manual process. For example, in some embodiments a device (e.g., a promotion server) may be programmed to cause groups and/or batches of session tickets to be created and/or printed based on one or more conditions (e.g., based on a schedule of entertainment events, utilization (either actual, predicted or historical) of one or more gaming device, etc.

Of course it should be understood that considerations other than the ending of an entertainment event may cause a group or batch of session tickets to be created and/or printed. For example, a casino may decide to initiate a promotion in which each guest checking into a hotel associated with the casino is provided a session ticket redeemable for a certain session upon check-in to the hotel (e.g., to promote a new game available in the casino or encourage play in a certain underutilized area of the casino).

A description of additional embodiments and additional description of some already described embodiments is provided below.

In some embodiments, a casino (e.g., resort property) may offer “Value Packages” including gambling and other goods/services. By purchasing a “Value Package,” a player may receive, for a single price (e.g., $100), (i) one or more session tickets which the player may utilize to execute one or more sessions, and/or (ii) an entitlement to one or more other elements, such as goods/services provided by a casino (e.g., hotel, spa, golf, restaurant, etc.), which also may typically be provided by means of a voucher or other tangible medium for said good/service (e.g., voucher for “one pedicure at casino spa”).

A value package may be provided (e.g., sold) to a player in a variety of manners (e.g., via any manner described herein with respect to session tickets (e.g., a kiosk, a gaming device, the Internet, a hotel room TV unit, a handheld device, a casino representative, a booth or desk on the casino floor or a hotel front desk, postal or e-mail mailed to a player, being left in a player's hotel room or provided to a player at check-in to a casino hotel, any POS within a casino, etc.). In an example of using the Internet to provide a Value Package including one or more session tickets, a player may use a Web site to reserve, select, assembling and/or purchase a Value Package. In some embodiments, the player may not provide any payment for such a Value Package until arriving at a casino. In another embodiment, a player may provide online (or via telephone or otherwise prior to arriving at a casino) at least partial payment for the portions of the Value Package not related to gambling for which player may not provide payment for until arriving at casino). The player may then provide any payment due for gambling portions of the Value Package (e.g., a price of a session ticket) upon arriving at the casino with which the Value Package is associated. In some embodiments, a player may be provided with a Value Package or an offer for a Value Package upon an occurrence of an event (e.g., signing up for a player tracking program, hotel room check-in, etc.).

In accordance with some embodiments, a Value Package (or various elements thereof) may be embodied in one or more physical forms. For example, a brochure or pamphlet may be provided to a player. The brochure or pamphlet may include marketing text describing the various products and/or services included in the Value Package, vouchers, coupons and/or session tickets folded into the pamphlet or brochure or stored in a pouch thereof (in some embodiments such vouchers, coupons and/or session tickets may be attached by perforation to an edge of the pamphlet or brochure).

In one embodiments, a catalog of Value Packages available for purchase may be provided to a player. Such a catalog may include Value Packages categorized by theme (some example themes of Value Packages are described below).

In some embodiments, a booklet of session tickets (e.g., which includes a plurality of session tickets in bound form) may be provided to a player, such that individual session tickets may be detached via perforation.

Some example Value Packages and the various goods and/or services (some gambling related and others not) are now described.

In one example, a “Hotel Package” may be sold to a player, the Hotel Package including a reservation for a hotel room (or upgrade) in combination with gambling. For example, a player visits a check-in desk at a casino hotel. The player purchases a hotel room or room upgrade, and in conjunction, receives a session ticket entitling him to fifty hands of video poker. In such an example, a charge for both the upgrade and the session ticket may, in some embodiments, be applied to hotel room bill. Thus, a computing device at check-in may be configured to communicate with one or more databases described above (or similar databases). For example, a session tickets database 600 may be updated to reflect an issuance of a session ticket included in this or any other Value Package. In one example of a provision of a Hotel Package, a player may pay $80 and receives a pamphlet including a room key and a session ticket redeemable for 200 hands of video poker play.

It should be noted that in one or more embodiments in which a Value Package is sold which includes a session ticket, a device (e.g., controller 105) or other entity (e.g., casino employee) may assign a monetary value (e.g., $16.00 out of a $80.00 Value Package price) attributable to the session ticket. This monetary value of the session ticket may be stored in a database (e.g., in association with the session ticket identifier in the appropriate record of the session tickets database), for use in some embodiments (e.g., for use by a gaming device in amortizing a price of the session ticket over a number of game plays of the session corresponding to the session ticket, for purposes of appropriately updating the coin-in meter of the gaming device).

In another example, a “Restaurant Package” may include specific food and/or drink items (or categories of such) and/or credit for a restaurant or other food/drink establishment, packaged with gambling via one or more session tickets. For example, a “Celebration Dinner Package” may include two appetizers, two entrees, two desserts and a bottle of champagne at a French restaurant, along with various session tickets redeemable for sessions at various gaming devices within a casino. In another example, a “Steak and Poker Package” may include a steak dinner, one beer, and three different session tickets, each for 200 hands of play at a different type of video poker game. In yet another example, a “Martini Package” may include one martini at casino martini bar and one session ticket redeemable for ten spins of a $5 denomination slot machine.

In one or more embodiments, a player may qualify to receive a session ticket upon performing one or more activities and/or making one or more purchases. For example, to encourage purchases of high-margin menu items, players can be offered a session ticket as an incentive by a retailer. For example, certain menu items at a restaurant come with a session ticket for 100 spins of a penny slot game. In another example, a player may be provided with an offer for a session ticket good for an extra payline during a session (e.g., a session upgrade session ticket which the player may insert into a gaming device in conjunction with another session ticket redeemable for a session) if the player buys dessert at a restaurant. In one or more embodiments, a computing device of a restaurant (e.g., a POS device) may be operable to communicate with one or more databases described herein to effectuate the provision of a session ticket to a player (e.g., by accessing a session tickets database 600). In other embodiments, a restaurant or other retailer affiliated with a casino may be provided with a set of session tickets that it may provide to customers and may not need to communicate with any such database. It should be understood that a restaurant or other retailer affiliated with a casino may purchase such session ticket from a casino (e.g., at cost) or may be provided the session tickets at no charge.

In another example of a type of Value Package, a “Live Entertainment Package” may include access to live entertainment in combination with access to gambling via a session ticket. For example, an “Early Show Package” may include two tickets to an early Cirque de Soleil™ show, and twp session tickets redeemable for 100 spins each at slot machine game. In another example, a “Blues Night Package” may include a nightclub entry for live music performance, and four session tickets good for thirty minutes of play each at various slot machines made by a particular manufacturer.

In yet another example of a type of Value Package, a “Merchandise Package” may include merchandise (or credit, coupon or voucher therefore) in combination with a session ticket. For example, a “Shopping Spree Package” may include vouchers good for $100 in credit at each of three casino shops, one session ticket for 100 spins of a Shopping Spree slots game, and one session ticket for 200 spins of Get Rich Quick Deluxe slots machine.

Of course, Value Packages may include other types of casino or resort services including but not limited to rounds of golf, spa visits or particular treatments, gym or pool access or services, transportation (e.g., convertible car rental, chauffer service), theme park access, zoo access, etc.

In some embodiments, a package or set of session tickets may be sold or otherwise provided to a player (as compared to a single session ticket or a session ticket packaged with non-gambling activities, goods or services). For example, a Gambling Variety Package may be provided which includes one or more session tickets redeemable for various types of gambling. For example, a “Beginner's Slot Sampler Package” may include session tickets redeemable for 15 minutes of play at each of 10 different types of slot games. In another example, a “Tournament Play Plus Package” may grant access to the 2 p.m. slot tournament as well as providing session tickets for sessions valid any time after 3 p.m. In yet another example, a “Weekend Bonanza Package” may include (i) three tickets for 200 spins each of three different types of slot games redeemable on Friday; (ii) three tickets for 200 spins each of three different types of slot games redeemable on Saturday; and (iii) three tickets for 200 spins each of three different types of slot games redeemable on Sunday.

Other examples of packages which combine non-gambling products and/or services with session tickets include: (i) a “Whirlwind Weekend Package for Two” that includes two show tickets, dinner for two at two different casino restaurants, and various session tickets redeemable at various times throughout the weekend; (ii) a “Bachelorette Party Package” that includes dinner for eight, nightclub admission for eight, sixteen different session tickets each redeemable for an hour of slot play; (iii) a “Business Conference Package”; and (iv) a “Dinner, a Show and Gambling Package.”

In some embodiments, a player or other entity (e.g., a company purchasing value packages for its customers, employees or attendees of a conference) may customize a Value Package or have a customized Value Package suggested to them. For example, in one embodiment player and/or customer data may be available to a casino (e.g., stored in a player database of a casino server). Such data may include demographics, gambling history, stated preferences, and so on. Value Package offers may be tailored/customized based on this data. For example, a gaming device may prompt a player “Would you like to buy a package including a 150-spin session of this game, and a round of golf tomorrow (tee time between 6 a.m. and 9 a.m. for only $75? Press here for more info).” In another example (e.g. a “Build-A-Package” embodiment) players on bus may each get packages of 10 session tickets from which they may choose any five for redemption.

In one embodiment, a “Mystery Package” may be provided, in which Value Package which includes at least one element unknown by player before purchase. For example, a session ticket included in such a package may specify “At least 500 slot spins” but not specify an exact number of spins and/or a game type. In another example, a “Wild Card” session ticket may be provided which is redeemable for anywhere from 100 to 1000 spins (e.g., exact number of spins may be revealed to the player once the player redeems the session ticket).

In one embodiments, a player may be allowed to exchange and/or alter one or more components of a Value Package. Means of exchanging and/or altering a Value Package may include, for example, any of the devices described herein, which may be operable to facilitate such an exchange and/or alteration. For example, a dedicated Web site or kiosk may be utilized for such a function. In another example, a player may instruct a casino representative to exchange and/or alter a component of a Value Package (the representative may then use a handheld device or PC to effectuate the exchange or alteration).

In one embodiment, players may trade components of Value Packages amongst themselves. For example, a player may be allowed to exchange a session ticket redeemable for one type of slot play with another player having a session ticket redeemable for another type of slot play.

In one embodiment, a Value Package may be upgraded and/or a duration of an aspect (e.g., a session, an expiration date) of a Value Package may be extended). For example, a player having purchased a Value Package may be able to purchase additional elements at a discounted rate (cheaper than they'd otherwise be available). For example, a player may be able to add an extra 150-hand video poker session to a Value Package for only $15 (retail price $20). In another example, a player may upgrade from a session for 300 spins of 5-payline slots to a session for 300 spins of 9-payline slots for $3. In one embodiment, a casino employee may be able to upgrade elements of a Value Package associated with a player (e.g., a casino employee may comp a player by scanning a session ticket and adding fifty spins to the duration of the session).

In one or more embodiments, a holder of a Value Package may surrender the Value Package. For example, a player may forfeit one or more elements of a Value Package in exchange for a refund (cash, comp points, etc.).

In one or more embodiments, a player may be able to view a status of a Value Package by viewing a status of one or more components of the Value Package. For example, the player may be able to view which elements of the Value Package have been redeemed and which haven't (e.g., via a television system in the player's hotel room).

In one or more embodiments, one or more package bonuses may be provided to a player based on game results of a session ticket included in the Value Package (e.g., if first four session tickets of five-ticket Value Package result in winnings sessions, the fifth session ticket is worth double the amount of play). In another embodiment, an order of redemption of a plurality of session tickets may have a bonus associated therewith (e.g., players may get benefits for redeeming elements of Value Package in a certain order, such being provided with fifty extra slot spins of a reeled slot machine session if they redeem the video poker session first). In another example, one element of a Value Package may be guaranteed to win (e.g., one out of five session tickets in a Value Package may be guaranteed to win or the player gets a refund amount).

In one embodiment, for Value Packages lasting longer periods of time (e.g., one month), players may periodically download/print session tickets they have already purchased (e.g., at kiosk on gaming floor, using home PC, etc.).

In one or more embodiments, a session ticket may have multiple potential uses. For example, a session ticket may have three potential uses. In some embodiments, redeeming the session ticket for one option may void or prohibit use of the other. For example, a session ticket may be redeemable for either 200 hands of video poker or 100 slot spins at particular machines. In another example, a session ticket has three potential uses; the player chooses one and the casino chooses only one of the remaining two uses and voids the third. In another example, a two-sided session ticket may have printed thereon different types of sessions on each side. A player may, for example, insert the session ticket face-up to redeem a first session and face-down to redeem a second session. In another example, a session ticket may also serve as an entry into a sweepstakes or drawing (e.g., when a player redeems the session ticket, he is automatically entered into the sweepstakes or drawing).

In one embodiment, simultaneous or substantially simultaneous redemption of two or more session tickets may be a requirement for redemption of any of the two or more session tickets. For example, in a multi-player embodiment, two session tickets must be inserted at (roughly) the same time on two different machines in order for either session ticket to be authorized for redemption. In some embodiments, benefits other than redemption authorization may be provided for such simultaneous usage of two or more session tickets. In other words, a session ticket may be redeemable by itself but if it is redeemed with another session ticket (e.g., at the same time as another session ticket), a player may be provided with an additional benefit (e.g., access to more paylines, an increased session duration, an increased wager amount per game play, access to a more favorable paytable, etc.). In another example, session tickets may be sold for less than retail price if a simultaneous use restriction applies.

In one or more embodiments, a session ticket may be first created (e.g., printed) or sold in an inactive state but may be activated upon an occurrence of an event. For example, a session ticket may be printed in an inactive state (e.g., a status of the session ticket may initially prohibit authorization of redemption of the session ticket) but may be activated (e.g., the status of the session ticket may be set such that it allows authorization of redemption) upon a purchase of the session ticket. For example, a casino employee may scan the session ticket to effectuate the change in status (e.g., based on the session ticket identifier, the appropriate record of the session tickets database is accessed and the status changed).

In another embodiment, session tickets may be displayed or made available to players in a hotel room (much like a mini-bar makes drinks and snacks available). In such embodiments, a player may only be charged a price for the session tickets that he redeems (e.g., the price may be charged to the player's hotel room bill).

In some embodiments, purchased session tickets may be stored electronically in association with player such that if player loses ticket, he can print a replacement (for example, a session ticket identifier may be stored in player account/database or stored in a memory of a cellular phone or other portable electronic device).

In some embodiments, a session ticket may have a variable value or more than one value for a particular parameter associated with it. For example, a session ticket may be redeemable for either (i) 800 spins of a reeled slot machine game within a first period of time or (ii) 700 spins of a reeled slot machine game within a second period of time. Different parameters (e.g., number of paylines, games, game types, wager amounts, etc.) may have different or multiple values (e.g., each value having a different qualifying condition associated therewith) associated therewith in a similar manner.

In one or more embodiments, a mapping function may be provided by a device described herein (e.g., a kiosk, gaming device, casino personnel device, controller, etc.) which, based on a session ticket identifier or session identifier, may provide a player with a map, directions or other assistance in locating a gaming device at which a session ticket may be redeemed. For example, a player may insert a session ticket redeemable for multiple game plays of a “Big Texas Knockout” game into a kiosk and, in response, the kiosk may output (e.g., via a display screen and/or printer) a map and/or directions to the closest gaming device operable to facilitate this game.

In some embodiments, a session ticket may trigger an auto-play session. For example, a player may insert a session ticket redeemable for 100 spins of a reeled slot game into a gaming device and, in response, 100 spins may automatically be generated. Systems and methods for automated play of gaming devices are described in Applicant's co-pending U.S. application Ser. No. 10/331,438, filed Dec. 27, 2002, entitled “METHOD AND APPARATUS FOR AUTOMATICALLY OPERATING A GAME MACHINE”; the entirety of this application is incorporated herein by reference for all purposes.

In some embodiments, receipt of a session ticket at a gaming device may not cause a configuration of the gaming device for a particular session, type of session or menu of sessions for which the session ticket may be redeemed, but rather merely triggers a “mode change” or a “prompt to player that mode switch is available” from standard play to session play. Once the gaming device switches modes, possible values of various parameters of a session may be determined (e.g., a player inserts a session ticket, and the gaming device in response outputs a “configure your session” screen, from which the player picks various options).

In one or more embodiments a player may be allowed to provide a session ticket for a gambling session that is already in progress (e.g., to replenish his credit balance). For example, a player may be allowed to replenish his credit balance based on a “wildcard.”

In some embodiments, receipt of a session ticket may cause a processor (e.g., of a gaming device) to instruct an output device to indicate a different type of “balance” other than a balance of credits. For example, an LED credit meter may no longer indicate “credits” but instead (or in addition) indicate “spins” or “game plays.” Such a process may be part of the configuration process of a gaming device described with respect to Step 1015 (FIG. 10).

In one embodiment, a process may include “converting” standard machine credits into other session value/duration. For example: assume a slot machine has credit balance of 231; further assume a player inserts a session ticket redeemable for 200 spins of the slot machine; the slot machine may be configured such that player may execute the 200 spins, plus an additional amount of spins that the balance of 231 credits is converted into (e.g., based on denomination and/or an algorithm for converting monetary credits to a duration of a session of a particular type).

In some embodiments, as described above, a player may be allowed to vary a value of a parameter defining a session while executing the session. Thus, for example, a player may be allowed to switch from a first game or type of game to another game or type of game in the middle of the session. In some embodiments, such a switch may be accompanied by a translation of other values of other parameters defining the session. For example, such a translation process may include a determination of a new remaining duration for the session, a new session balance of credits, etc. In come embodiments, a player may be required to provide consideration for such a switch (e.g., some credits may be deducted from the player or a price may be otherwise charged to the player).

In some embodiments, a benefit may be provided to a player for having a friend's player tracking card inserted during a session. For example, to encourage new players to view those engaged in sessions, players of sessions might get a benefit (e.g., one-time benefit) if a different player's tracking card is inserted into a gaming device during a session.

In one embodiment, a player may provide a benefit during a session for achieving and/or maintaining a certain rate of play during the session. For example, a player may be provided with extra duration of the session (e.g., extra time or number of game plays).

In some embodiments, initiation of a session may not require a session ticket. Rather, the player may provide a code or other identifier which indicates that the player is entitled to redeem a session. For example, a player may indicate a session (and, e.g., cause a gaming device to be configured for the session) by providing a code via a keypad or touchscreen or providing a biometric identifier.

In some embodiments, a player may be provided a Session Pass via which the player may get an unlimited number of game plays, time or other duration of a session according to various restrictions. Restrictions may include time of day, gaming device, wager amount, a maximum of x cashouts per y unit time, a restriction indicating that a player can only cashout sessions of 100 or more spins with balances of $5 or more, and a restriction indication only one game of a particular type which a player may play per day.

In some embodiments in which a duration of a session is denoted in time (e.g., a 60-minute session), time may only count against the player while a game play is mid-execution (e.g., minutes/seconds are only taken away from the player's remaining duration “while the reels are spinning”).

In some embodiments, on the last game play of a session, a player may be allowed to place a wager as large as his credit balance will cover (e.g., $125.25), if he chooses.

In some embodiments, (e.g., in lieu of receiving a payout amount for a completed session), a player may enter a session into a contest (“Best Session of the Day” pays $10,000).

In some embodiments in which sessions are executed on wireless gaming devices (e.g., a dedicated wireless gaming device provided to the player by a casino), players may get benefits for playing in certain areas. For example, a player may be provided with extra game plays for a session if he plays in a restaurant.

Although many particular embodiments have been described herein, it should be understood that the invention is not limited to the particular embodiments described and that many modifications and adjustments are within the scope of the present invention.

### Rules of Interpretation for this Application

Numerous embodiments have been described, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention.

Accordingly, those skilled in the art will recognize that the present invention may be practiced with various modifications and alterations. Although particular features of the present invention may be described with reference to one or more particular embodiments or figures that form a part of the present disclosure, and in which are shown, by way of illustration, specific embodiments of the invention, it should be understood that such features are not limited to usage in the one or more particular embodiments or figures with reference to which they are described. The present disclosure is thus neither a literal description of all embodiments of the invention nor a listing of features of the invention that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, TDMA, CDMA, and 3G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device that accesses data in such a database.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

What is claimed is:

1. A method, comprising:
determining an occurrence of an event, the event being other than a request to purchase a session ticket;
issuing a session ticket based on the occurrence of the event, the session ticket being redeemable for a session,
wherein a session defines a plurality of game plays of a wagering game which plurality of game plays when obtained as a session are provided at a price that is less than if the plurality of game plays were to be purchased individually; and
providing a session ticket to a person associated with the event.

2. The method of claim 1, wherein the session further comprises a guarantee to the person to whom the session ticket is provided of a specific number of game plays which the person will be able to complete during the session.

3. The method of claim 1, wherein the session further comprises a guarantee of an amount of time for which the person to whom the session ticket is provided will be able to play the gaming device in order to complete the plurality of game plays.

4. The method of claim 1, wherein determining an occurrence of an event comprises determining an occurrence of an entertainment event associated with an audience.

5. The method of claim 4, wherein determining an occurrence of an entertainment even comprises determining that an entertainment event is scheduled to occur at a first time and is scheduled to end at a second time.

6. The method of claim 4, wherein issuing the session ticket based on the occurrence of the event comprises issuing a session ticket, wherein the session ticket is redeemable during a period of time that begins at substantially the second time.

7. The method of claim 5, wherein providing the session ticket comprises providing the session ticket to the person prior to the first time.

8. The method of claim 5, wherein providing the session ticket comprises providing the session ticket to the person at substantially the second time.

9. The method of claim 4, wherein providing the session ticket comprises providing the session ticket to a member of the audience.

10. The method of claim 1, wherein determining an occurrence of an event comprises determining that the person is checking into a hotel associated with a casino.

11. The method of claim 1, wherein issuing the session ticket comprises issuing a session ticket redeemable during a time at which the person will be a guest of the hotel.

12. The method of claim 1, wherein determining an occurrence of an event comprises determining that the person has purchased at least one of a good and a service, the purchase of which qualifies the person to receive the session ticket.

13. The method of claim 12, wherein determining that the person has purchased at least one of a good and a service comprises determining that the person has purchased a session.

14. The method of claim 12, wherein determining that the person has purchase at least one of a good and a service comprises determining at least one wager placed by the person on a wagering game.

15. The method of claim 12, wherein determining that the person has purchased at least one of a good and a service comprises determining that the person has made a reservation at a hotel associated with a casino.

16. The method of claim 12, wherein determining that the person has purchased at least one of a good and a service comprises determining that the person has purchased a menu item at a restaurant associated with a casino.

17. The method of claim 1, wherein issuing a session ticket comprises at least one of printing a session ticket, encoding data onto magnetic stripe of a session ticket, storing data in a memory of a session ticket and updating a record of a database to reflect the issuance of the session ticket.

18. The method of claim 1, wherein issuing a session ticket comprises issuing a session ticket at one of a gaming device, a kiosk located in a casino, a retailer associated with a casino, a handheld device operated by an employee of a casino and a point-of-sale of a casino.

19. The method of claim 1, wherein issuing a session ticket comprises issuing a group of session tickets, each session ticket being redeemable for a session.

20. The method of claim 19, wherein a first session ticket of the group is redeemable for a first session and a second session ticket of the group is redeemable for a second session.

21. The method of claim 20, wherein the first session is defined by a first value for a parameter of the first session and the second session is defined by a second value for the parameter of the second session, the first value being different from the second value.

22. The method of claim 21, wherein the parameter defines at least one of a game, type of game, gaming device and type of gaming device at which the session ticket is redeemable.

23. The method of claim 22, further comprising:
selecting the first value and the second value based on a utilization of at least one gaming device at a time associated with the event.

24. The method of claim 23, wherein the utilization is an expected utilization at the time.

25. The method of claim 23, wherein the utilization is an actual utilization at the time.

26. A system comprising:
a processor;
a memory storing a program for directing the processor,
the processor and the program being operable together to:
determine an occurrence of an event, the event being other than a request to purchase a session ticket;
issue a session ticket based on the occurrence of the event, the session ticket being redeemable for a session,
wherein a session defines a plurality of game plays of a wagering game which plurality of game plays when obtained as a session are provided at a price that is less than if the plurality of game plays were to be purchased individually; and
provide a session ticket to a person associated with the event.

27. A computer-readable medium storing a program for directing a processor to:
determine an occurrence of an event, the event being other than a request to purchase a session ticket;
issue a session ticket based on the occurrence of the event, the session ticket being redeemable for a session,
wherein a session defines a plurality of game plays of a wagering game which plurality of game plays when obtained as a session are provided at a price that is less than if the plurality of game plays were to be purchased individually; and
provide a session ticket to a person associated with the event.

28. A method, comprising:
determining a time at which a show at a casino property is scheduled to end;
causing a group of session tickets to be printed, each session ticket being redeemable
during a period of time which begins at the time the show is scheduled to end or within a half-hour of the time the show is scheduled to end and
for a plurality of game plays of a wagering game, the plurality being a number less than one hundred; and
providing, at no charge, a respective session ticket of the group to members of an audience of the show.

29. The method of claim 28, wherein providing comprises providing the session ticket with a ticket for admission to the show.

30. The method of claim 28, wherein providing comprises providing the session ticket with a program to the show.

31. The method of claim 28, wherein providing comprises providing the session ticket to the member as the member is exiting the show.

32. A method, comprising:
receiving an indication of a session,
wherein the session defines a plurality of game plays of a wagering game which plurality of game plays when obtained as a session are provided at a price that is less than if the plurality of game plays were to be purchased individually;
determining a gaming device at which the session is redeemable; and
outputting at least one of a map showing a location of the gaming device and directions to the gaming device from a first location.

33. The method of claim 32, wherein receiving the indication of the session comprises receiving at least one of a session identifier, a session ticket identifier and a player identifier.

34. The method of claim 33, wherein receiving the indication of the session comprises receiving a session ticket and determining the at least one of the session identifier, a session ticket identifier and a player identifier based on the session ticket.

35. The method of claim 32, wherein receiving an indication of a session comprises receiving the session identifier at least one of a gaming device and a kiosk.

36. The method of claim 32, wherein determining a gaming device at which the session is redeemable comprises:
determining a characteristic of a game for which the session is redeemable; and
determining a gaming device operable to facilitate a game having the characteristic.

37. The method of claim 36, wherein determining the gaming device operable to facilitate the game having the characteristic comprises accessing a database storing data defining respective characteristics of available gaming devices.

38. The method of claim 32, wherein determining the gaming device at which the session is redeemable further comprises:
determining a status of the gaming device operable to facilitate the game having the characteristic; and
selecting the gaming device that is operable to facilitate the game having the characteristic and that has an associated status indicating that the gaming device is currently available for play.

39. The method of claim 36, wherein determining the gaming device at which the session is redeemable further comprises:
determining a location at which a player is currently located; and
selecting a gaming device operable to facilitate the game having the characteristic based on the location at which the player is currently located.

40. The method of claim 39, wherein selecting a gaming device operable to facilitate the game having the characteristic based on the location at which the player is currently located comprises:
selecting a gaming device operable to facilitate the game having the characteristic that is closest to the location at which the player is currently located.

41. The method of claim 32, wherein outputting comprises:
outputting, via a display device, at least one of a map showing a location of the gaming device and directions to the gaming device from a first location.

42. The method of claim 32, wherein outputting comprises:
causing a printer to print at least one of a map showing a location of the gaming device and directions to the gaming device from a first location.

43. The method of claim 32, wherein outputting comprises wirelessly transmitting to a handheld device at least one of a map showing a location of the gaming device and directions to the gaming device from a first location.

44. The method of claim 32, wherein the map includes a highlighting, marking or other emphasis of the location of the gaming device.

45. The method of claim 32, wherein the first location is a location at which a player associated with the session is currently located.

46. The method of claim 32, wherein the first location is a landmark location.

47. A system comprising:
a processor;
a memory storing a program for directing the processor,
the processor and the program being operable together to:
receive an indication of a session,
wherein the session defines a plurality of game plays of a wagering game which plurality of game plays when obtained as a session are provided at a price that is less than if the plurality of game plays were to be purchased individually;
determine a gaming device at which the session is redeemable; and
output at least one of a map showing a location of the gaming device and directions to the gaming device from a first location.

48. A computer-readable medium storing a program for directing a processor to:
receive an indication of a session,
wherein the session defines a plurality of game plays of a wagering game which plurality of game plays when obtained as a session are provided at a price that is less than if the plurality of game plays were to be purchased individually;
determine a gaming device at which the session is redeemable; and
output at least one of a map showing a location of the gaming device and directions to the gaming device from a first location.

49. A method comprising:
selling a package of entitlements to a player, each entitlement entitling the player to a good or service associated with a casino, in which package at least one of the entitlements entitles the player to a session,
wherein the session defines a plurality of game plays of a wagering game which plurality of game plays when obtained as a session are provided at a price that is less than if the plurality of game plays were to be purchased individually.

50. The method of claim 49, wherein at least one of the entitlements is an entitlement to at least one of a non-gambling product and a non-gambling service.

51. The method of claim 50, wherein selling comprises:
selling, via the Internet, the package of entitlements to a player.

52. The method of claim 51, further comprising:
charging the player for a portion of a price associated with the package at the time of purchase, wherein the time of purchase is prior to a player's arrival at a casino and
wherein the portion of the price is a portion attributable to at least a portion of at least one of the at least one of the non-gambling product and a non-gambling service.

53. The method of claim 49, wherein the session further comprises a guarantee to the player of entitlement to a session of a specific number of game plays which the player will have the opportunity to complete during the session.

54. The method of claim 49, wherein the session further comprises a guarantee of an entitlement to a session of a specific amount of time for which the player entitled to the session will be able to play the gaming device in order to complete the plurality of game plays.

55. The method of claim 49, further comprising:
providing to the player a catalog of available packages of entitlements, wherein each package available via the catalog entitles the player to a session.

56. The method of claim 49, further comprising:
providing a representation of the package to the player, wherein the representation includes a session ticket for each session included in the package.

57. A system comprising:
a processor;
a memory storing a program for directing the processor,
the processor and the program being operable together to:
sell a package of entitlements to a player, each entitlement entitling the player to a good or service associated with a casino, in which package at least one of the entitlements entitles the player to a session,
wherein the session defines a plurality of game plays of a wagering game which plurality of game plays when obtained as a session are provided at a price that is less than if the plurality of game plays were to be purchased individually.

58. A computer-readable medium storing a program for directing a processor to:
sell a package of entitlements to a player, each entitlement entitling the player to a good or service associated with a casino, in which package at least one of the entitlements entitles the player to a session,
wherein the session defines a plurality of game plays of a wagering game which plurality of game plays when obtained as a session are provided at a price that is less than if the plurality of game plays were to be purchased individually.

59. A method, comprising:
receiving from a gaming device a session ticket identifier identifying a session ticket received at the gaming device;
validating the session ticket identifier;
determining an identifier identifying a group of at least one session corresponding to the session ticket identifier,
wherein the session ticket is redeemable for the at least one session and
wherein the session defines a plurality of game plays of a wagering game which plurality of game plays when obtained as a session are provided at a price that is less than if the plurality of game plays were to be purchased individually;
communicating to the gaming device the indication of the identifier identifying the group.

60. The method of claim 59, wherein the identifier identifying the group identifies a plurality of sessions and wherein the session ticket is redeemable for a one of the plurality of sessions.

61. The method of claim 59, wherein the identifier identifying the group identifies a single session.

62. The method of claim 59, further comprising:
determining whether a redemption of the session ticket is to be authorized; and
if the redemption is to be authorized, communicating to the gaming device an indication that the redemption is authorized.

63. The method of claim 62, wherein determining whether a redemption of the session ticket is to be authorized comprises:
determining at least one restriction on a redemption of the session ticket that is associated with the session ticket identifier; and
determining whether a current condition satisfies the restriction.

64. The method of claim 62, further comprising:
if the redemption is not to be authorized, communicating to the gaming device an indication that the redemption is not authorized.

65. The method of claim 64, wherein the indication that the redemption is not to be authorized includes an indication of a reason why the redemption is not authorized.

66. The method of claim 59, further comprising:
storing in a database an indication that the session ticket has been redeemed.

67. A system comprising:
a processor;
a memory storing a program for directing the processor,
the processor and the program being operable together to:
receive from a gaming device a session ticket identifier identifying a session ticket received at the gaming device;
validate the session ticket identifier;
determine an identifier identifying a group of at least one session corresponding to the session ticket identifier,
wherein the session ticket is redeemable for the at least one session and
wherein the session defines a plurality of game plays of a wagering game which plurality of game plays when obtained as a session are provided at a price that is less than if the plurality of game plays were to be purchased individually;
communicating to the gaming device the indication of the identifier identifying the group.

68. A computer-readable medium storing a program for directing a processor to:
receive from a gaming device a session ticket identifier identifying a session ticket received at the gaming device;
validate the session ticket identifier;
determine an identifier identifying a group of at least one session corresponding to the session ticket identifier,
wherein the session ticket is redeemable for the at least one session and
wherein the session defines a plurality of game plays of a wagering game which plurality of game plays when obtained as a session are provided at a price that is less than if the plurality of game plays were to be purchased individually;
communicating to the gaming device the indication of the identifier identifying the group.
